(19) United States
(12) Patent Application Publication
(10) Pub. No.: US 2024/0336271 A1
(43) Pub. Date: Oct. 10, 2024

(54) METHOD, PROCESSING SYSTEM, AND RECORDING DEVICE

(71) Applicant: DENSO CORPORATION, Kariya-city (JP)

(72) Inventors: TETSUYA TOHDO, Kariya-city (JP); ATSUSHI BABA, Kariya-city (JP); HIROSHI KUWAJIMA, Kariya-city (JP)

(21) Appl. No.: 18/747,280

(22) Filed: Jun. 18, 2024

Related U.S. Application Data
(63) Continuation of application No. PCT/JP2022/046804, filed on Dec. 20, 2022.

(30) Foreign Application Priority Data
Dec. 21, 2021 (JP) 2021-207405

(51) Int. Cl. B60W 40/10; B60W 40/02; B60W 50/00

(52) U.S. Cl. CPC B60W 40/10; B60W 40/02; B60W 50/0098

(57) ABSTRACT

A method to be executed by at least one processor to implement a dynamic driving task in a driving system of a moving object is provided. The method includes: defining, as ranges indicating a control state of the moving object, a performance limit range that is a range having a performance limit of the driving system as a boundary and a stable-control possible range in which stable control is maintainable within the performance limit range; determining the range such that a determination as to whether the control state is within or outside the stable-control possible range is included; and deriving a control action of the moving object so as to switch control according to the determination.

### CROSS REFERENCE TO RELATED APPLICATION

The present application is a continuation application of International Patent Application No. PCT/JP2022/046804 filed on Dec. 20, 2022 which designated the U.S. and claims the benefit of priority from Japanese Patent Application No. 2021-207405 filed on Dec. 21, 2021. The entire disclosures of all of the above applications are incorporated herein by reference.

### TECHNICAL FIELD

The disclosure in this specification relates to a technique for implementing a driving system of a moving object.

### BACKGROUND

A technique disclosed in a related art determines whether a risk value indicating a risk of collision between a subject vehicle and another object exceeds a threshold defined in advance. When the risk level of the collision is lower than the threshold, a braking force is not applied.

### SUMMARY

A method to be executed by at least one processor to implement a dynamic driving task in a driving system of a moving object is provided. The method includes: defining, as ranges indicating a control state of the moving object, a performance limit range that is a range having a performance limit of the driving system as a boundary and a stable-control possible range in which stable control is maintainable within the performance limit range; determining the range such that a determination as to whether the control state is within or outside the stable-control possible range is included; and deriving a control action of the moving object so as to switch control according to the determination.

### BRIEF DESCRIPTION OF DRAWINGS

Objects, features and advantages of the present disclosure will become more apparent from the following detailed description made with reference to the accompanying drawings. In the drawings:

FIG. 1 is a block diagram illustrating a schematic configuration of a driving system;

FIG. 2 is a block diagram illustrating a technical level configuration of the driving system;

FIG. 3 is a block diagram illustrating a functional level configuration of the driving system;

FIG. 4 is a diagram illustrating a control state space of a vehicle;

FIG. 5 is a block diagram illustrating a causal loop of the driving system;

FIG. 6 is a diagram illustrating an inner loop;

FIG. 7 is a diagram illustrating an outer loop;

FIG. 8 is a diagram illustrating areas in which safety cannot be maintained based on a concept of a first evaluation method;

FIG. 9 is a flowchart illustrating the first evaluation method;

FIG. 10 is a diagram illustrating areas in which safety cannot be maintained based on a concept of a second evaluation method;

FIG. 11 is a flowchart illustrating the second evaluation method;

FIG. 12 is a diagram illustrating areas in which safety cannot be maintained based on a concept of a third evaluation method;

FIG. 13 is a flowchart illustrating the third evaluation method;

FIG. 14 is a table illustrating a relationship between control states and control actions;

FIG. 15 is a diagram illustrating a relationship between a relative position of an obstacle and a controllable range;

FIG. 16 is a flowchart illustrating switching of control actions;

FIG. 17 is a flowchart illustrating switching of control actions;

FIG. 18 is a flowchart illustrating switching of control actions;

FIG. 19 is a block diagram illustrating a perception control subsystem;

FIG. 20 is a flowchart illustrating a design method of the driving system;

FIG. 21 is a flowchart illustrating determination of a performance limit range;

FIG. 22 is a block diagram illustrating a functional level configuration of the driving system; and

FIG. 23 is a block diagram illustrating a technical level configuration of the driving system.

### DETAILED DESCRIPTION

However, in the technique of a related art, the stability of control of the subject vehicle has not been taken into consideration. Accordingly, when the risk level of collision increases, if the control of the subject vehicle is in an unstable state, there is a concern that an occupant may feel uneasy regarding whether an appropriate action can be executed.

The present disclosure provides a method and a driving system for implementing a dynamic driving task with a strong sense of security. The present disclosure provides a recording device for implementing a driving system with a strong sense of security.

According to one aspect of the disclosure, a method to be executed by at least one processor to implement a dynamic driving task in a driving system of a moving object, the method comprises: defining, as ranges indicating a control state of the moving object, a performance limit range that is a range having a performance limit of the driving system as a boundary and a stable-control possible range in which stable control is maintainable within the performance limit range; determining the range such that a determination as to whether the control state is within or outside the stable-control possible range is included; and deriving a control action of the moving object so as to switch control according to the determination.

According to one aspect of the disclosure, a processing system for implementing a dynamic driving task of a moving object comprises at least one processor. The processor is configured to: define, as ranges indicating a control state of the moving object, a performance limit range that is a range having a performance limit of a driving system of the moving object as a boundary and a stable-control possible range in which stable control is maintainable within the performance limit range; determine the range such that a determination as to whether the control state is within or outside the stable-control possible range is included; and derive a control action of the moving object so as to switch control according to the determination.

According to this aspect, the control action of the moving object is derived according to the determination as to whether the control state is within the stable-control possible range. The stable-control possible range is associated with the performance limit range and is defined as a range in which the stable control can be maintained within the performance limit range. That is, the control action is derived from the viewpoint of whether the driving system can maintain stable control in consideration of the performance limit. Since it is also possible to switch the control action before the performance limit is reached, a strong sense of security can be given to the occupant.

According to one aspect of the present disclosure, a recording device for recording a state of a driving system of a moving object records: defining, as ranges indicating a control state of the moving object, a performance limit range that is a range having a performance limit of the driving system as a boundary and a stable-control possible range in which stable control is maintainable within the performance limit range; a fact that the driving system has executed minimal risk maneuver (MRM); and information indicating which range of the ranges the control state is in, the information being used for determination to execute the MRM and the information being determined based on a situation estimated by the driving system.

According to this aspect, information indicating which range the control state is in is recorded. Since this information is information determined based on the situation estimated by the driving system, an estimation result or a determination result by the driving system at the time when the MRM is executed can be easily subjected to follow-up verification.

The reference numerals in parentheses in the claims exemplarily indicate a correspondence relationship with parts of the embodiment described later, and are not intended to limit the technical scope.

Hereinafter, multiple embodiments will be described with reference to the drawings. It should be noted that the same reference numerals are allocated to the corresponding components in the respective embodiments, so that overlapping descriptions may be omitted. When only a part of the configuration is described in each embodiment, the configurations of the other embodiments described above can be applied to the other parts of the configuration. Further, not only the combinations of the configurations explicitly shown in the description of the respective embodiments, but also the configurations of the plurality of embodiments can be partially combined even when they are not explicitly shown as long as there is no difficulty in the combination in particular.

### First Embodiment

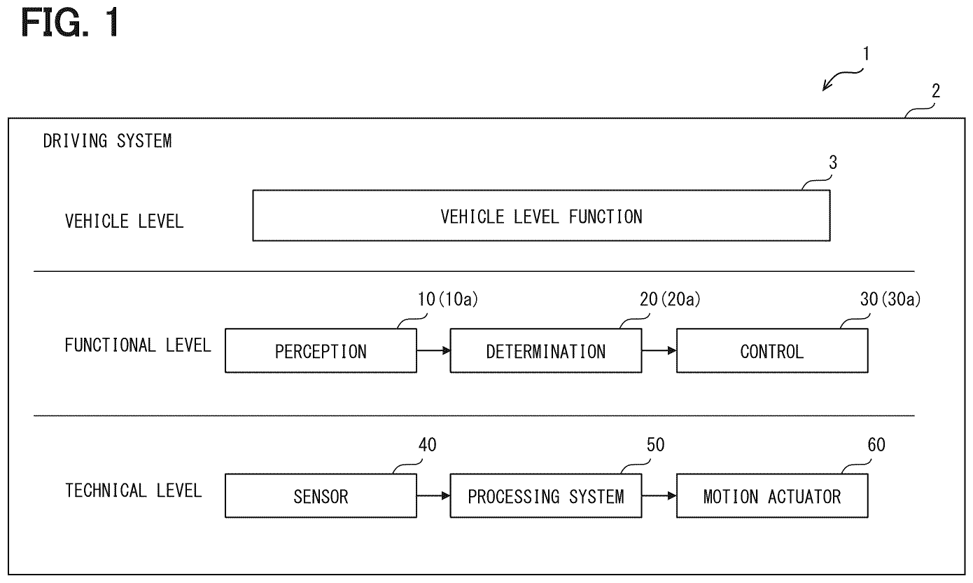

A driving system 2 of a first embodiment illustrated in FIG. 1 implements functions related to driving a moving object. A part or all of the driving system 2 is mounted on a moving object. The moving object to be processed by the driving system 2 is a vehicle. This vehicle can be referred to as a subject vehicle 1 and corresponds to a host moving object. The subject vehicle 1 may be capable of communicating with another vehicle directly or indirectly via a communication infrastructure. The other vehicle corresponds to a target moving object.

The subject vehicle 1 is a road user such as an automobile or a truck capable of executing autonomous driving. The driving is classified into levels according to a range or the like of all dynamic driving tasks (DDT) that a driver performs. Autonomous driving levels are defined in SAE J3016, for example. At Levels 0 to 2, the driver performs a part or all of the DDT. Levels 0 to 2 may be classified as so-called manual driving. Level 0 indicates that driving is not automated. Level 1 indicates that the driving system 2 supports the driver. Level 2 indicates that driving is partially automated.

At Level 3 or higher, the driving system 2 performs all of the DDT while engaged. Levels 3 to 5 may be classified as so-called autonomous driving. The driving system 2 capable of executing driving at Level 3 or higher may be referred to as an autonomous driving system. Level 3 indicates that driving is conditionally automated. Level 4 indicates that driving is highly automated. Level 5 indicates that driving is fully automated.

Further, the driving system 2 that cannot perform driving at Level 3 or higher but can perform driving at least one of Levels 1 and 2 may be referred to as a driving support system. In the following, when there is no particular situation of specifying the maximum autonomous driving level that can be implemented, the description will be continued by simply referring to the automated driving system or the driving support system as the driving system 2.

### <Sense-Plan-Act Model>

An architecture of the driving system 2 is selected so as to enable implementation of an efficient safety of the intended functionality (SOTIF) process. For example, the architecture of the driving system 2 may be configured based on a sense-plan-act model. The sense-plan-act model includes a sense element, a plan element, and an act element as main system element. The sense element, the plan element, and the act element interact with each other. Here, sense can be read as perception, plan as determination (judgment), and act as control. Hereinafter, the description will be continued mainly using the words perception, determination, and control.

As illustrated in FIG. 1, at a vehicle level in the driving system 2, a vehicle level function 3 is implemented based on a vehicle level safety strategy (VLSS). At a functional level (in other words, in a functional perspective), a perception function, a determination function, and a control function are implemented. At a technical level (in other words, in a technical perspective), multiple sensors 40 corresponding to the perception function, a processing system 50 corresponding to the determination function, and multiple motion actuators 60 corresponding to the control function are mounted.

Specifically, a perception unit 10, which is a functional block that implements the perception function, may be constructed in the driving system 2, mainly including the multiple sensors 40, a processing system that processes detection information of the multiple sensors 40, and a processing system that generates an environment model based on information of the multiple sensors 40. A determination unit 20, which is a functional block that implements the determination function, may be constructed in the driving system 2, mainly including a processing system. A control unit 30, which is a functional block that implements the control function, may be constructed in the driving system 2, mainly including the multiple motion actuators 60 and at least one processing system that outputs operation signals of the multiple motion actuators 60.

Here, the perception unit 10 may be implemented in the form of a perception system 10a serving as a subsystem provided to be distinguishable from the determination unit 20 and the control unit 30. The determination unit 20 may be implemented in the form of a determination system 20a serving as a subsystem provided to be distinguishable from the perception unit 10 and the control unit 30. The control unit 30 may be implemented in the form of a control system 30a serving as a subsystem provided to be distinguishable from the perception unit 10 and the determination unit 20. The perception system 10a, the determination system 20a, and the control system 30a may constitute components independent of each other.

Further, multiple human machine interface (HMI) devices 70 may be mounted on the subject vehicle 1. A portion of the multiple HMI devices 70 that implements an operation input function for an occupant may be a part of the perception unit 10. A portion of the multiple HMI devices 70 that implements an information presentation function may be a part of the control unit 30. On the other hand, a function implemented by the HMI device 70 may be positioned as a function independent of the determine function, the determination function, and the control function.

The perception unit 10 performs the perception function including localization of a road user such as the subject vehicle 1 and another vehicle. The perception unit 10 detects an external environment EE, an internal environment, a vehicle state, and further a state of the driving system 2 of the subject vehicle 1. The perception unit 10 generates an environment model by integrating detected information. The determination unit 20 derives a control action by applying a purpose and a driving policy to the environment model generated by the perception unit 10. The control unit 30 executes the control action derived by the determination unit 20.

### <System Configuration at Technical Level>

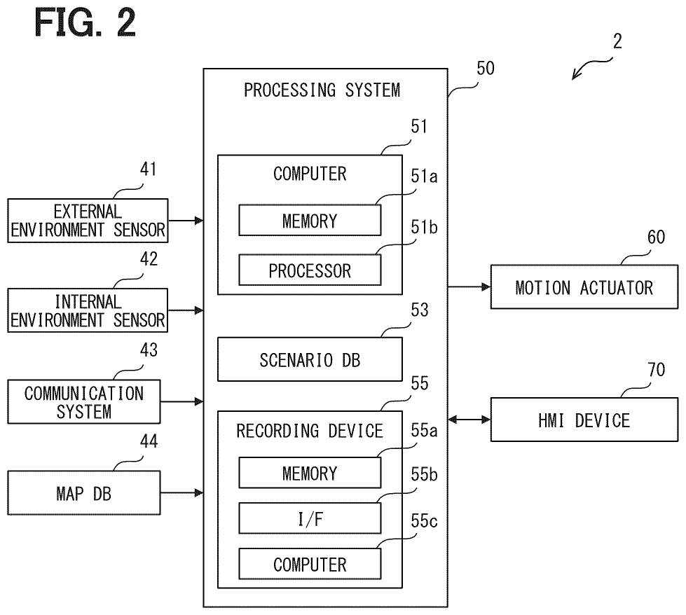

An example of a detailed configuration of the driving system 2 at the technical level will be described with reference to FIG. 2. A technical level configuration may mean a physical architecture. The driving system 2 includes the multiple sensors 40, the multiple motion actuators 60, the multiple HMI devices 70, and at least one processing system 50. These components can communicate with each other through one or both of a wireless connection and a wired connection. These components may be able to communicate with each other through an in-vehicle network such as CAN (registered trademark).

The multiple sensors 40 include one or more external environment sensors 41. The multiple sensors 40 may include at least one type of one or more internal environment sensors 42, one or more communication systems 43, and a map database (DB) 44. When the sensor 40 is narrowly interpreted as indicating the external environment sensor 41, the internal environment sensor 42, the communication system 43, and the map DB 44 may be positioned as components different from the sensor 40 corresponding to the technical level of the perception function.

The external environment sensor 41 may detect a target present in the external environment EE of the subject vehicle 1. Examples of the external environment sensor 41 of a target detection type include a camera, a light detection and ranging/laser imaging detection and ranging (LiDAR) laser radar, a millimeter wave radar, and an ultrasonic sonar. Typically, multiple types of external environment sensors 41 may be combined and mounted in order to monitor directions of a front side, lateral sides, and a rear side of the subject vehicle 1.

As a mounting example of the external environment sensor 41, multiple cameras (for example, 11 cameras) configured to monitor directions of the front side, a front lateral side, the lateral sides, a rear lateral side, and the rear side of the subject vehicle 1 may be mounted on the subject vehicle 1.

As another mounting example, multiple cameras (for example, 4 cameras) configured to monitor the front side, the lateral sides, and the rear side of the subject vehicle 1, multiple millimeter wave radars (for example, 5 millimeter wave radars) configured to monitor the front side, the front lateral side, the lateral sides, and the rear side of the subject vehicle 1, and a LiDAR configured to monitor the front side of the subject vehicle 1 may be mounted on the subject vehicle 1.

Further, the external environment sensor 41 may detect a state of the atmosphere or a state of the weather in the external environment EE of the subject vehicle 1. Examples of the external environment sensor 41 of a state detection type include an outside air temperature sensor, a temperature sensor, and a raindrop sensor.

The internal environment sensor 42 may detect a specific physical quantity (hereinafter, a motion physical quantity) related to a vehicle motion in the internal environment of the subject vehicle 1. Examples of the internal environment sensor 42 of a motion physical quantity detection type include a speed sensor, an acceleration sensor, and a gyro sensor. The internal environment sensor 42 may detect a state of the occupant in the internal environment of the subject vehicle 1. Examples of the internal environment sensor 42 of an occupant detection type include an actuator sensor, a driver status monitor, a biosensor, a seating sensor, and an in-vehicle device sensor. In particular, examples of the actuator sensor include an accelerator sensor, a brake sensor, and a steering sensor that detect an operating state of the occupant with respect to the motion actuator 60 related to motion control of the subject vehicle 1.

The communication system 43 acquires communication data that can be used in the driving system 2 by wireless communication. The communication system 43 may receive a positioning signal from an artificial satellite in a global navigation satellite system (GNSS) existing in the external environment EE of the subject vehicle 1. Examples of a positioning type communication device in the communication system 43 include a GNSS receiver.

The communication system 43 may transmit and receive communication signals to and from a V2X system present in the external environment EE of the subject vehicle 1. Examples of a V2X type communication device in the communication system 43 include a dedicated short range communications (DSRC) communication device, and a cellular V2X (C-V2X) communication device. The communication with the V2X system present in the external environment EE of the subject vehicle 1 includes communication with a communication system of another vehicle (V2V), communication with infrastructure equipment such as a communication device set in a traffic light (V21), communication with a mobile terminal of a pedestrian (V2P), communication with a network such as a cloud server (V2N), and the like.

Further, the communication system 43 may transmit and receive a communication signal to and from a mobile terminal such as a smartphone present in the internal environment of the subject vehicle 1, for example, in the vehicle. Examples of a communication device of a terminal communication type in the communication system 43 include a Bluetooth (registered trademark) device, a Wi-Fi (registered trademark) device, and an infrared communication device.

The map DB 44 is a database that stores map data that can be used in the driving system 2. The map DB 44 includes, for example, at least one type of non-transitory tangible storage medium among a semiconductor memory, a magnetic medium, an optical medium, and the like. The map DB 44 may include a database of a navigation unit that navigates a travel path to a destination of the subject vehicle 1. The map DB 44 may include a database of a PD map generated using probe data (PD) collected from vehicles. The map DB 44 may include a database of a high-precision map having a high level of precision mainly used for the automated driving system. The map DB 44 may include a database of a parking lot map including detailed parking lot information used for automatic parking or parking support, for example, parking frame information.

The map DB 44 suitable for the driving system 2 acquires and stores the latest map data through, for example, communication with a map server via the V2X type communication system 43. The map data is two-dimensional or three-dimensional data representing the external environment EE of the subject vehicle 1. The map data may include, for example, road data representing at least one type among position coordinates of a road structure, a shape, a road surface condition, and a standard traveling road. The map data may include, for example, marking data representing at least one type of position coordinates, a shape, and the like for a road sign, a road marking, and a lane marking attached to a road. The marking data included in the map data may represent targets, for example, a traffic sign, an arrow marking, a lane marking, a stop line, a direction sign, a landmark beacon, a business sign, and a change in a line pattern of a road. The map data may include structure data representing at least one type among positional coordinates, a shape, and the like of a building and a traffic light facing the road, for example. The marking data included in the map data may represent targets, for example, a streetlight, an edge of a road, a reflecting plate, and a pole.

The motion actuator 60 can control the vehicle motion based on an input control signal. The motion actuator 60 of a drive type is a power train including at least one type among an internal combustion engine, a drive motor, and the like. The motion actuator 60 of a braking type is, for example, a brake actuator. The motion actuator 60 of a steering type is, for example, a steering wheel.

The HMI device 70 may be an operation input device capable of inputting an operation performed by the driver for transmitting a purpose or an intention of an occupant including the driver of the subject vehicle 1 to the driving system 2. Examples of the HMI device 70 of an operation input type include an accelerator pedal, a brake pedal, a shift lever, a steering wheel, a turn signal lever, a mechanical switch, and a touch panel of a navigation unit. Among those, the accelerator pedal controls the power train serving as the motion actuator 60. The brake pedal controls the brake actuator serving as the motion actuator 60. The steering wheel controls a steering actuator serving as the motion actuator 60.

The HMI device 70 may be an information presentation device that presents information such as visual information, auditory information, and skin sensation information to an occupant including the driver of the subject vehicle 1. Examples of the HMI device 70 of a visual information presentation type include a combination meter, a navigation unit, a center information display (CID), a head-up display (HUD), and an illumination unit. Examples of the HMI device 70 of an auditory information presentation type include a speaker and a buzzer. Examples of the HMI device 70 of a skin sensation information presentation type include a vibration unit of the steering wheel, a vibration unit of the driver's seat, a reaction force unit of the steering wheel, a reaction force unit of the accelerator pedal, a reaction force unit of the brake pedal, and an air conditioning unit.

The HMI device 70 may implement an HMI function in cooperation with a mobile terminal such as a smartphone by communicating with the mobile terminal through the communication system 43. For example, the HMI device 70 may present information acquired from the smartphone to the occupant including the driver. Further, for example, an operation input to the smartphone may be used as an alternative to an operation input to the HMI device 70.

At least one processing system 50 is provided. For example, the processing system 50 may be an integrated processing system that integrally executes processing related to the perception function, processing related to the determination function, and processing related to the control function. In this case, the integrated processing system 50 may further execute processing related to the HMI device 70, and an HMI dedicated processing system may be separately provided. For example, the HMI dedicated processing system may be an integrated cockpit system that integrally executes processing related to each HMI device.

Further, for example, the processing system 50 may include at least one processing unit corresponding to the processing related to the perception function, at least one processing unit corresponding to the processing related to the determination function, and at least one processing unit corresponding to the processing related to the control function.

The processing system 50 includes a communication interface for the outside, and is connected to at least one type of elements related to the processing performed by the processing system 50 among the sensor 40, the motion actuator 60, the HMI device 70, and the like via at least one type among, for example, a local area network (LAN), a wire harness, an internal bus, and a wireless communication circuit.

The processing system 50 includes at least one dedicated computer 51. The processing system 50 may implement functions such as the perception function, the determination function, and the control function by combining multiple dedicated computers 51.

For example, the dedicated computer 51 constituting the processing system 50 may be an integrated ECU that integrates driving functions of the subject vehicle 1. The dedicated computer 51 constituting the processing system 50 may be a determination ECU that determines a DDT. The dedicated computer 51 constituting the processing system 50 may be a monitoring ECU that monitors driving of the vehicle. The dedicated computer 51 constituting the processing system 50 may be an evaluation ECU that evaluates the driving of the vehicle. The dedicated computer 51 constituting the processing system 50 may be a navigation ECU that navigates the travel path of the subject vehicle 1.

The dedicated computer 51 constituting the processing system 50 may be a locator ECU that estimates a position of the subject vehicle 1. The dedicated computer 51 constituting the processing system 50 may be an image processing ECU that processes image data detected by the external environment sensor 41. The dedicated computer 51 constituting the processing system 50 may be an actuator ECU that controls the motion actuator 60 of the subject vehicle 1. The dedicated computer 51 constituting the processing system 50 may be an HMI control unit (HCU) that integrally controls the HMI device 70. The dedicated computer 51 constituting the processing system 50 may be, for example, at least one external computer that constructs an external center or a mobile terminal capable of communication via the communication system 43.

The dedicated computer 51 constituting the processing system 50 includes at least one memory 51a and at least one processor 51b. The memory 51a may be at least one type of non-transitory tangible storage medium among, for example, a semiconductor memory, a magnetic medium, and an optical medium that non-temporarily store programs, data, and the like that can be read by the computer 51. Further, a rewritable volatile storage medium such as a random access memory (RAM) may be provided as the memory 51a. The processor 51b includes, as a core, at least one type among a central processing unit (CPU), a graphics processing unit (GPU), a reduced instruction set computer (RISC)-CPU, and the like.

The dedicated computer 51 constituting the processing system 50 may be a system on a chip (SoC) that is implemented by integrating a memory, a processor, and an interface into one chip, or may include the SoC as a component of the dedicated computer.

Further, the processing system 50 may include at least one database for executing a dynamic driving task. The database includes at least one type of non-transitory tangible storage medium among, for example, a semiconductor memory, a magnetic medium, and an optical medium. The database may be a scenario DB 53 that is a database of a scenario structure described later.

The processing system 50 may include at least one recording device 55 that records at least one of perception information, determination information, and control information of the driving system 2. The recording device 55 may include at least one memory 55a and an interface 55b for writing data to the memory 55a. The memory 55a may be at least one type of non-transitory tangible storage medium among, for example, a semiconductor memory, a magnetic medium, and an optical medium.

At least one of the memories 55a may be mounted on a substrate in a form that is not easily detachable or replaceable, and in this form, for example, an embedded multi media card (eMMC) using a flash memory may be adopted. At least one of the memories 55a may be mounted in a form that is detachable and replaceable with respect to the recording device 55, and in this form, for example, an SD card may be adopted.

The recording device 55 may have a function of selecting information to be recorded from the perception information, the determination information, and the control information. In this case, the recording device 55 may include a dedicated computer 55c. A processor provided in the recording device 55 may temporarily store information in a RAM or the like. The processor may select information to be recorded from the temporarily stored formation and store the selected information in the memory 51a.

The recording device 55 may access the memory 55a and execute recording in accordance with a data write command from the perception system 10a, the determination system 20a, or the control system 30a. The recording device 55 may determine information flowing in the in-vehicle network, and based on the determination of the processor provided in the recording device 55, access the memory 55a and execute recording. Recording in the recording device 55 may be executed after various types of data to be recorded are generated in a predetermined format set in advance.

### <Functional Level System Configuration>

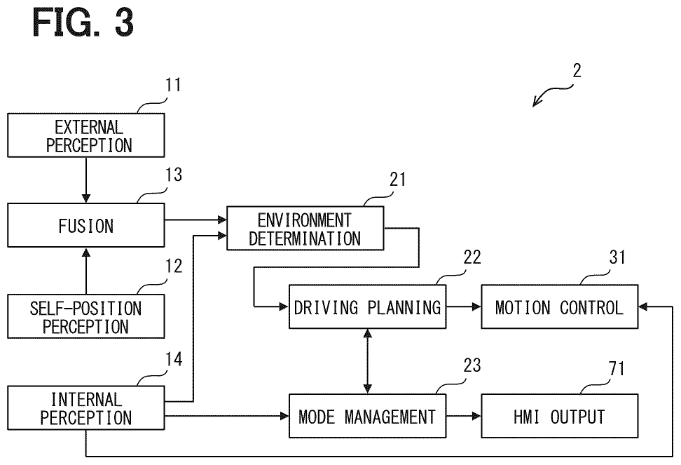

Next, an example of a detailed configuration of the driving system 2 at the functional level will be described with reference to FIG. 3. The functional level configuration may refer to a logical architecture. The perception unit 10 includes an external perception unit 11, a self-position perception unit 12, a fusion unit 13, and an internal perception unit 14 as sub-blocks into which the perception function is further divided.

The external perception unit 11 individually processes detection data detected by each external environment sensor 41, and implements a function of recognizing an object such as a target or another road user. The detection data may be detection data provided from, for example, a millimeter wave radar, a sonar, or a LIDAR. The external perception unit 11 may generate relative position data including a direction, a size, and a distance of the object with respect to the subject vehicle 1 based on raw data detected by external environment sensor 41.

The detection data may be image data provided from, for example, a camera or a LiDAR. The external perception unit 11 processes the image data and extracts an object that is reflected in an angle of view of the image. The extraction of the object may include estimation of a direction, a size, and a distance of the object with respect to the subject vehicle 1. The extraction of the object may include object class classification using, for example, semantic segmentation.

The self-position perception unit 12 performs localization of the subject vehicle 1. The self-position perception unit 12 acquires global position data of the subject vehicle 1 from the communication system 43 (for example, a GNSS receiver). In addition, the self-position perception unit 12 may acquire at least one of position information of a target extracted by the external perception unit 11 and position information of the target extracted by the fusion unit 13. The self-position perception unit 12 acquires map information from the map DB 44. The self-position perception unit 12 integrates these types of information to estimate a position of the subject vehicle 1 on the map.

The fusion unit 13 fuses external perception information of each external environment sensor 41 processed by the external perception unit 11, localization information processed by the self-position perception unit 12, and V2X information acquired by the V2X.

The fusion unit 13 fuses object information of other road users and the like individually perceived by each external environment sensor 41, and specifies types and relative positions of objects around the subject vehicle 1. The fusion unit 13 fuses target information of a road individually perceived by each external environment sensor 41, and specifies a static structure of the road around the subject vehicle 1. The static structure of the road includes, for example, a curve curvature, the number of lanes, and a free space.

Next, the fusion unit 13 generates an environment model by fusing the types and relative positions of the objects around the subject vehicle 1, the static structure of the road around the subject vehicle 1, the localization information, and the V2X information. The environment model can be provided to the determination unit 20. The environment model may be an environment model specialized for modeling the external environment EE.

The environment model may be an integrated environment model obtained by integrating information such as an internal environment, a vehicle state, and a state of the driving system 2, which is implemented by extending the acquired information. For example, the fusion unit 13 may acquire a traffic rule such as a road traffic law and reflect the traffic rule in the environment model.

The internal perception unit 14 processes detection data detected by each internal environment sensor 42 and implements a function of perceiving a vehicle state. The vehicle state may include a state of a motion physical quantity of the subject vehicle 1 detected by a speed sensor, an acceleration sensor, a gyro sensor, or the like. The vehicle state may include at least one of the state of the occupant including the driver, an operating state of the driver with respect to the motion actuator 60, and a switch state of the HMI device 70.

The determination unit 20 includes an environment determination unit 21, a driving planning unit 22, and a mode management unit 23 as sub-blocks into which the determination function is further divided.

The environment determination unit 21 acquires the environment model generated by the fusion unit 13, the vehicle state perceived by the internal perception unit 14, and the like, and determines the environment based on the environment model, the vehicle state, and the like. Specifically, the environment determination unit 21 may interpret the environment model and estimate a situation in which the subject vehicle 1 is currently placed. The situation here may be an operational situation. The environment determination unit 21 may interpret the environment model and predict a trajectory of an object such as another road user. The environment determination unit 21 may interpret the environment model and predict a potential hazard.

The environment determination unit 21 may interpret the environment model and perform determination regarding a scenario in which the subject vehicle 1 is currently placed. The determination regarding a scenario may be to select at least one scenario, in which the subject vehicle 1 is currently placed, from a catalog of scenarios constructed in the scenario DB 53. The determination regarding a scenario may be determination of a scenario category described later.

Further, the environment determination unit 21 may estimate the intention of the driver based on at least one of a predicted trajectory of an object, a predicted potential hazard, and the determination regarding a scenario, and on the vehicle state provided from the internal perception unit 14.

The driving planning unit 22 plans the driving of the subject vehicle 1 based on at least one of estimation information on the position of the subject vehicle 1 on the map obtained by the self-position perception unit 12, determination information and driver intention estimation information obtained by the environment determination unit 21, function restriction information obtained by the mode management unit 23, and the like.

The driving planning unit 22 implements a route planning function, a behavior planning function, and a trajectory planning function. The route planning function is a function of planning at least one of a route to a destination and a lane plan at a middle distance based on the estimation information on the position of the subject vehicle 1 on the map. The route planning function may further include a function of determining at least one of a lane change request and a deceleration request based on the lane plan at the middle distance. Here, the route planning function may be a mission/route planning function in a strategic function, and may output a mission plan and a route plan.

The behavior planning function is a function of planning a behavior of the subject vehicle 1 based on at least one of the route to the destination, the lane plane at the middle distance, the lane change request and the deceleration request planned by the route planning function, the determination information and the driver intention estimation information obtained by the environment determination unit 21, and the function restriction information obtained by the mode management unit 23. The behavior planning function may include a function of generating a condition regarding a state transition of the subject vehicle 1. The condition regarding a state transition of the subject vehicle 1 may correspond to a triggering condition. The behavior planning function may include a function of determining, based on this condition, a state transition of an application that implements a DDT, and further a state transition of a driving action. The behavior planning function may include a function of determining, based on information on the state transitions, a restriction on a longitudinal direction of a path of the subject vehicle 1 and a restriction on a lateral direction of the path of the subject vehicle 1. The behavior planning function may be a tactical behavior plan in a DDT function, and may output a tactical behavior.

The trajectory planning function is a function of planning a traveling trajectory of the subject vehicle 1 based on the determination information obtained by the environment determination unit 21, the restriction on the longitudinal direction of the path of the subject vehicle 1, and the restriction on the lateral direction of the path of the subject vehicle 1. The trajectory planning function may include a function of generating a path plan. The path plan may include a speed plan, and the speed plan may be generated as a plan independent of the path plan. The trajectory planning function may include a function of generating multiple path plans and selecting an optimum path plan from the multiple path plans or a function of switching between the path plans. The trajectory planning function may further include a function of generating backup data of the generated path plans. The trajectory planning function may be a trajectory planning function in the DDT function, and may output a trajectory plan.

The mode management unit 23 monitors the driving system 2 and sets a restriction on functions related to driving. The mode management unit 23 may monitor states of the subsystems related to the driving system 2 and determine a malfunction of the driving system 2. The mode management unit 23 may determine a mode based on the intention of the driver based on the driver intention estimation information generated by the internal perception unit 14. The mode management unit 23 may set the restriction on the functions related to driving based on at least one of a determination result of the malfunction of the driving system 2, a determination result of the mode, the vehicle state obtained by the internal perception unit 14, a sensor abnormality (or sensor failure) signal output from the sensor 40, the state transition information of the application and the trajectory plan obtained by the driving planning unit 22, and the like.

The mode management unit 23 may have an integrated function of determining the restriction on the longitudinal direction of the path of the subject vehicle 1 and the restriction on the lateral direction of the path of the subject vehicle 1 in addition to the restriction on the functions related to driving. In this case, the driving planning unit 22 plans the behavior and plans the trajectory according to the restrictions determined by the mode management unit 23.

The control unit 30 includes a motion control unit 31 and an HMI output unit 71 as sub-blocks into which the control function is further divided. The motion control unit 31 controls the motion of the subject vehicle 1 based on the trajectory plan (for example, the path plan and the speed plan) acquired from the driving planning unit 22. Specifically, the motion control unit 31 generates accelerator request information, shift request information, brake request information, and steering request information according to the trajectory plan, and outputs the generated information to the motion actuator 60.

Here, the motion control unit 31 can directly acquire the vehicle state perceived by the perception unit 10 (particularly, the internal perception unit 14), for example, at least one of a current speed, an acceleration, and a yaw rate of the subject vehicle 1 from the perception unit 10, and reflect the vehicle state in the motion control of the subject vehicle 1.

The HMI output unit 71 outputs information related to the HMI based on at least one of the determination information and the driver intention estimation information obtained by the environment determination unit 21, the state transition information of the application and the trajectory plan obtained by the driving planning unit 22, the function restriction information obtained by the mode management unit 23, and the like. The HMI output unit 71 may manage vehicle interaction. The HMI output unit 71 may generate a notification request based on a management state of the vehicle interaction and control an information notification function of the HMI device 70. Further, the HMI output unit 71 may generate control requests for a wiper, a sensor cleaning device, a headlight, and an air conditioner based on the management state of the vehicle interaction, and control these devices.

### <Scenario>

In order to execute a dynamic driving task or evaluate the dynamic driving task, a scenario-based approach may be adopted. As described above, processes necessary for executing the dynamic driving task in the autonomous driving are classified into a disturbance in a perception element, a disturbance in a determination element, and a disturbance in a control element, which have different physical principles. A factor (root cause) affecting a processing result in each element is structured as a scenario structure.

The disturbance in the perception element is a perception disturbance. The perception disturbance is a disturbance indicating a state in which the perception unit 10 cannot correctly percept a hazard due to an internal factor or an external factor of the sensor 40 and the subject vehicle 1. The internal factor includes, for example, instability related to attachment or manufacturing variations of a sensor such as the external environment sensor 41, inclination of the vehicle due to a non-uniform load that changes an orientation of the sensor, and shielding of the sensor due to attachment of a component to the outside of the vehicle. Examples of the external factor include fogging and stain on the sensor. The physical principle of the perception disturbance is based on a sensor mechanism of each sensor.

The disturbance in the determination element is a traffic disturbance. The traffic disturbance is a disturbance indicating a hazardous traffic condition that occurs as a result of a combination of a geometric shape of a road, a behavior of the subject vehicle 1, and a position and a behavior of a surrounding vehicle. The physical principle of the traffic disturbance is based on a geometrical viewpoint and an operation of a road user.

The disturbance in the control element is a vehicle disturbance. The vehicle disturbance may be referred to as a control disturbance. The vehicle disturbance is a disturbance indicating a situation in which there is a possibility that the vehicle cannot control its dynamics due to an internal factor or an external factor. Examples of the internal factor include a total weight and weight balance of the vehicle. Examples of the external factor include road surface irregularity, inclination, and wind. The physical principle of the vehicle disturbance is based on mechanical action input to a tire and a vehicle body.

In order to cope with a collision of the subject vehicle 1 with another road user or a structure, which is a risk in a dynamic driving task of the autonomous driving, a traffic disturbance scenario system in which a traffic disturbance scenario is systematized is used as a scenario structure. With respect to the traffic disturbance scenario system, a reasonably foreseeable range or a reasonably foreseeable boundary can be defined, and an avoidable range or an avoidable boundary can be defined.

The avoidable range or the avoidable boundary can be defined, for example, by defining and modeling performance of a competent and careful human driver. The performance of a competent and careful human driver can be defined in three elements of the perception element, the determination element, and the control element.

Examples of the traffic disturbance scenario include a cut-in scenario, a cut-out scenario, and a deceleration scenario. The cut-in scenario is a scenario in which another vehicle traveling in an adjacent lane of the subject vehicle 1 merges in front of the subject vehicle 1. The cut-out scenario is a scenario in which a preceding vehicle to be followed by the subject vehicle 1 performs a lane change to an adjacent lane. In this case, it is required to perform a proper response to a fallen object suddenly appearing in front of the subject vehicle 1, a stopped vehicle at the end of traffic congestion, or the like. The deceleration scenario is a scenario in which a preceding vehicle to be followed by the subject vehicle 1 suddenly decelerates.

The traffic disturbance scenario can be generated by systematically analyzing and classifying different combinations of a geometric shape of a road, an operation of the subject vehicle 1, a position of another vehicle in the surroundings, and an operation of the other vehicle in the surroundings.

Here, a structure of the traffic disturbance scenario on a highway will be described as an example of a systemized traffic disturbance scenario. The road shape is classified into four categories of a main lane, merging, branching, and a ramp. The operation of the subject vehicle 1 is classified into two categories of lane keeping and lane changing. The position of the other vehicle in the surroundings is defined by, for example, adjacent positions in the surroundings in eight directions where there is a possibility of intruding into a traveling trajectory of the subject vehicle 1. Specifically, the eight directions indicate leading, following, parallel traveling on the right front side (parallel: Pr-f), parallel traveling on the right side (parallel: Pr-s), parallel traveling on the right rear side (parallel: Pr-r), parallel traveling on the left front side (parallel: Pl-f), parallel traveling on the left side (parallel: Pl-s), and parallel traveling on the left rear side (parallel: Pl-r). The operation of the other vehicle in the surroundings is classified into five categories, that is, cut-in, cut-out, acceleration, deceleration, and synchronization. The deceleration may include stopping.

Among combinations of positions and operations of the other vehicle in the surroundings, there are a combination that may cause a reasonably foreseeable obstacle and a combination that may not cause a reasonably foreseeable obstacle. For example, the cut-in may occur in six categories of parallel traveling. The cut-out may occur in two categories, that is, preceding and following. The acceleration may occur in three categories, that is, following, parallel traveling on the right rear side, and parallel traveling on the left rear side. The deceleration may occur in three categories, that is, preceding, parallel traveling on the right front side, and parallel traveling on the left front side. The synchronization may occur in two categories, that is, parallel traveling on the right side and parallel traveling on the left side. Accordingly, the structure of the traffic disturbance scenario on the highway is constituted by a matrix including 40 possible combinations. The structure of the traffic disturbance scenario may be expanded to include a complicated scenario by further considering at least one of a motorcycle and multiple vehicles.

Next, a perception disturbance scenario system will be described. The perception disturbance scenario may include a blind spot scenario (also referred to as a shielding scenario) and a communication disturbance scenario in addition to a sensor disturbance scenario involving an external environment sensor.

The sensor disturbance scenario can be generated by systematically analyzing and classifying different combinations of factors and sensor mechanism elements.

Among factors of a sensor disturbance, factors related to the vehicle and the sensor are classified into three categories, that is, the subject vehicle 1, the sensor, and a front surface of the sensor. Factors of the subject vehicle 1 include, for example, a change in a vehicle posture. Factors of the sensor include, for example, a mounting variation and a malfunction of a sensor main body. Factors of the front surface of the sensor include an attached matter and a change in characteristics, and include glare in the case of a camera. For these factors, the influence according to the sensor mechanism specific to each external environment sensor 41 may be assumed as a perception disturbance.

Among the factors of the sensor disturbance, factors related to the external environment are classified into three categories, that is, surrounding structures, space, and surrounding moving objects. The surrounding structures are classified into three categories, that is, road surfaces, roadside structures, and overhead structures based on a positional relationship with the subject vehicle 1. Factors of the road surface include, for example, a shape, a road surface condition, and a material. Factors of the roadside structure include, for example, reflection, shielding, and background. Factors of the overhead structure include, for example, reflection, shielding, and background. Factors of the space include, for example, space obstacles, radio waves and light in space. Factors of the surrounding moving object include, for example, reflection, shielding, and background. For these factors, the influence according to the sensor mechanism specific to each external environment sensor may be assumed as a perception disturbance.

Among the factors of the sensor disturbance, factors related to an object to be perceived by the sensor are roughly classified into four categories, that is, traveling roads, traffic information, roadblocks, and moving objects.

The traveling roads are classified into lane markings, structures having a height, and road edges based on a structure of an object indicating a traveling road. The road edges are classified into a road edge having no step and a road edge having a step. Factors of the lane marking include, for example, a color, a material, a shape, a stain, a thin spot, and a relative position. Factors of the structure having a height include, for example, a color, a material, a stain, and a relative position. Factors of the road edge having no step include, for example, a color, a material, a stain, and a relative position. Factors of the road edge having a step include, for example, a color, a material, a stain, and a relative position. For these factors, the influence according to the sensor mechanism specific to each external environment sensor may be assumed as a perception disturbance.

The traffic information is classified into signals, signs, and road markings based on a display form. Factors of the signal include, for example, a color, a material, a shape, a light source, a stain, and a relative position. Factors of the sign include, for example, a color, a material, a shape, a light source, a stain, and a relative position. Factors of the road marking include, for example, a color, a material, a shape, a stain, and a relative position. For these factors, the influence according to the sensor mechanism specific to each external environment sensor 41 may be assumed as a perception disturbance.

The roadblocks are classified into fallen objects, animals, and installed objects based on presence or absence of movement and a magnitude of the degree of influence in the case of collision with the subject vehicle 1. Factors of the fallen object include, for example, a color, a material, a shape, a size, a relative position, and a behavior. Factors of the animal include, for example, a color, a material, a shape, a size, a relative position, and a behavior. Factors of the installed object include, for example, a color, a material, a shape, a size, a stain, and a relative position. For these factors, the influence according to the sensor mechanism specific to each external environment sensor 41 may be assumed as a perception disturbance.

The moving objects are classified into other vehicles, motorcycles, bicycles, and pedestrians based on the type of a traffic participant. Factors of the other vehicle include, for example, a color, a material, a coating, a surface texture, an attached matter, a shape, a size, a relative position, and a behavior. Factors of the motorcycle include, for example, a color, a material, an attached matter, a shape, a size, a relative position, and a behavior. Factors of the bicycle include, for example, a color, a material, an attached matter, a shape, a size, a relative position, and a behavior. Factors of the pedestrian include, for example, a color and a material of what that is worn on the body, a posture, a shape, a size, a relative position, and a behavior. For these factors, the influence according to the sensor mechanism specific to each external environment sensor 41 may be assumed as a perception disturbance.

The sensor mechanism that causes the perception disturbance is classified into perception processing and others. Disturbances caused in the perception processing are classified into a disturbance related to a signal from an object to be perceived and a disturbance that interferes the signal from the object to be perceived. The disturbance that interferes the signal from the object to be perceived is, for example, noise or an unnecessary signal.

In particular, in camera perception processing, physical quantities characterizing the signal of the object to be perceived are, for example, strength, an azimuth, a range, a change in signal, and an acquisition time. Regarding the noise and the unnecessary signal, there are a case where the contrast is low and a case where the noise is large.

In particular, in LiDAR perception processing, physical quantities characterizing the signal of the object to be perceived are, for example, a scan timing, strength, a propagation direction, and a speed. The noise and the unnecessary signal are, for example, DC noise, pulsed noise, multiple reflection, and reflection or refraction from an object other than the object to be perceived.

In particular, in the millimeter wave radar, there is a disturbance caused by the orientation of the sensor as a disturbance classified into other categories. In millimeter wave radar perception processing, physical quantities characterizing the signal of the object to be perceived are, for example, a frequency, a phase, and strength. The noise and the unnecessary signal are, for example, small signal disappearance due to a circuit signal, a phase noise component of an unnecessary signal or signal embedding due to radio wave interference, and an unnecessary signal from a source other than the object to be perceived.

The blind spot scenario is classified into three categories, that is, another vehicle in the surroundings, a road structure, and a road shape. In the blind spot scenario caused by the other vehicle in the surroundings, the other vehicle in the surroundings may induce a blind spot that also affects other vehicles. Therefore, a position of the other vehicle in the surroundings may be based on an expansion definition in which adjacent positions in the surrounding in eight directions are expanded. In the blind spot scenario caused by the other vehicle in the surroundings, possible blind spot vehicle movements are classified into cut-in, cut-out, acceleration, deceleration, and synchronization.

The blind spot scenario caused by the road structure is defined in consideration of the position of the road structure and a relative operation pattern between the subject vehicle 1 and another vehicle present in the blind spot or a virtual other vehicle assumed to be in the blind spot. The blind spot scenario caused by the road structure is classified into a blind spot scenario caused by an external barrier and a blind spot scenario caused by an internal barrier. For example, a blind spot area occurs at curves by the external barrier.

The blind spot scenario caused by the road shape is classified into a longitudinal gradient scenario and an adjacent lane gradient scenario. In the longitudinal gradient scenario, a blind spot area occurs in one or both of the front and the rear of the subject vehicle 1. In the adjacent lane gradient scenario, a blind spot area occurs on a merging road, a branch road, and the like due to a height difference with the adjacent lane.

The communication disturbance scenario is classified into three categories, that is, a sensor, an environment, and a transmitter. The communication disturbance related to the sensor is classified into a map factor and a V2X factor. The communication disturbance related to the environment is classified into a static entity, a spatial entity, and a dynamic entity. The communication disturbance related to the transmitter is classified into another vehicle, infrastructure equipment, a pedestrian, a server, and a satellite.

Next, a vehicle disturbance scenario system will be described. The vehicle disturbance scenario is classified into two categories, that is, a vehicle body input and a tire input. The vehicle body input is an input in which an external force acts on the vehicle body and affects a motion in at least one direction among the longitudinal direction, the lateral direction, and a yaw direction. Elements affecting the vehicle body are classified into road shapes and natural phenomena. Examples of the road shape include a single gradient, a longitudinal gradient, and a curvature of a curved portion. Examples of the natural phenomenon include a cross wind, a tail wind, and a head wind.

The tire input is an input that varies a tire generated force and affects a motion in at least one direction among the longitudinal direction, the lateral direction, an up-down direction, and the yaw direction. Elements affecting a tire are classified into a road surface condition and a tire condition.

Examples of the road surface condition include a friction coefficient between the road surface and the tire, an external force to the tire, and the like. Here, road surface factors that affect the friction coefficient are classified into, for example, a wet road, an icy road, a snow-covered road, a partially graveled road, and a road surface marking. The road surface factors that affect the external force on the tire include, for example, a pothole, a protrusion, a step, a rut, a joint, and grooving. Examples of the tire condition include a puncture, a burst, and tire wear.

The scenario DB 53 may include at least one of a functional scenario, a logical scenario, and a concrete scenario. The functional scenario defines a top-level qualitative scenario structure. The logical scenario is a scenario obtained by assigning a quantitative parameter range to a structured functional scenario. The concrete scenario defines a boundary of safety determination that distinguishes between a safe state and an unsafe state.

The unsafe state is, for example, a hazardous situation. A range corresponding to the safe state may be referred to as a safe range, and a range corresponding to the unsafe state may be referred to as an unsafe range. Further, a condition that contributes to the inability to prevent, detect, and mitigate a hazardous behavior or a reasonably foreseeable misuse of the subject vehicle 1 in a scenario may be a triggering condition.

The scenario can be classified as known or unknown, and hazardous or non-hazardous. That is, the scenario can be classified into a known hazardous scenario, a known non-hazardous scenario, an unknown hazardous scenario, and an unknown non-hazardous scenario.

The scenario DB 53 may be used for determination regarding an environment in the driving system 2 as described above, or may be used for verification and validation of the driving system 2. A method of verifying and validating the driving system 2 may be referred to as an evaluation method of the driving system 2.

### <Safety and Security>

The driving system 2 estimates a situation and controls the behavior of the subject vehicle 1. The driving system 2 avoids an accident and a hazardous situation leading to an accident as much as possible and maintains a safe situation or safety. The hazardous situation may be caused as a result of a maintenance state of the subject vehicle 1 or a failure of the driving system 2. The hazardous situation may also be caused by the outside such as by another road user. The driving system 2 maintains safety by changing the behavior of the subject vehicle 1 by reacting to an event in which a safe situation cannot be maintained due to an external factor such as another road user.

The driving system 2 has control performance for stabilizing the behavior of the subject vehicle 1 in a safe state. The safe state depends not only on the behavior of the subject vehicle 1 but also on the situation. When the control of stabilizing the behavior of the subject vehicle 1 in a safe state cannot be performed, the driving system 2 acts to minimize the harm or risk of an accident. Here, the harm of an accident may mean damage caused to a traffic participant (road user) when a collision occurs, or a magnitude of damage. The risk may be based on a magnitude and likelihood of harm, and may be, for example, a product of the magnitude and likelihood of harm.

A behavior that minimizes the harm or risk of an accident, or the best way to derive the behavior may be referred to as a best effort. The best effort may include a best effort that capable of guaranteeing that the automated driving system minimizes the severity or risk of an accident (hereinafter referred to as a “best effort capable of guaranteeing a minimal risk”). The best effort capable of guaranteeing a minimal risk may mean minimal risk maneuver (MRM) or DDT fallback. The best effort may include a best effort that cannot guarantee the minimization of the harm or risk of an accident but attempts to reduce and minimize the severity or risk of the accident within control capacity (hereinafter referred to as a “best effort that cannot guarantee a minimal risk).

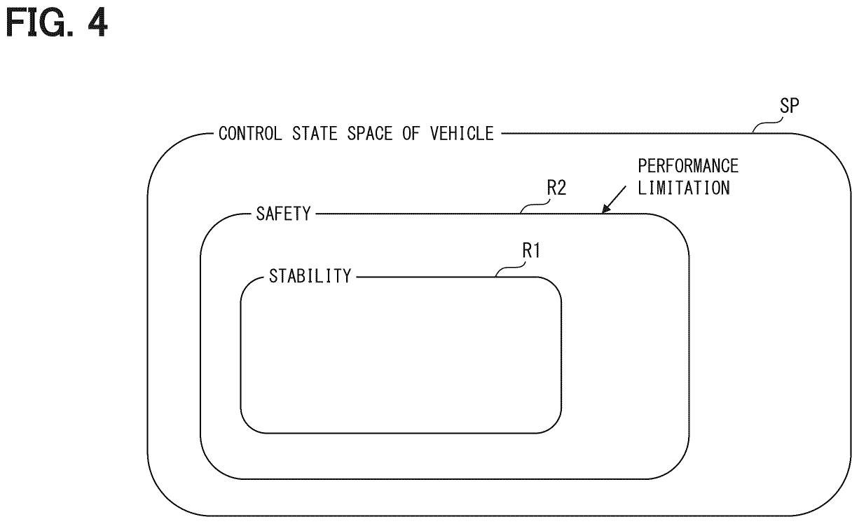

FIG. 4 illustrates a control state space SP that spatially represents the control state of the vehicle. The driving system 2 may have control performance for stabilizing the behavior of the subject vehicle 1 in a range that has a margin on the safety side from a system performance limit capable of ensuring safety. The system performance limit capable of ensuring safety may be a boundary between the safe state and the unsafe state, that is, a boundary between the safe range and the unsafe range. An operational design domain (ODD) in the driving system 2 is typically set within a performance limit range R2, and more preferably set outside a stable-control possible range R1. The performance limit range R2 corresponds to an example of a second range. The stable-control possible range R1 corresponds to an example of a first range.

The range having a margin on the safe side from the performance limit may be referred to as a stable range. In the stable range, the driving system 2 can maintain a safe state by a nominal operation as designed. A state in which a safe state can be maintained by a nominal operation as designed may be referred to as a stable state. The stable state can provide the occupant or the like with “usual security”. Here, the stable range may be referred to as the stable-control possible range R1 in which stable control is possible.

In addition, in a portion outside the stable-control possible range R1 and within the performance limit range R2, the driving system 2 can return the control to the stable state on the premise that an environmental assumption holds. The environmental assumption may be, for example, a reasonably foreseeable assumption. For example, the driving system 2 can change the behavior of the subject vehicle 1 in reaction to a reasonably foreseeable behavior of a road user or the like to avoid entering a hazardous situation, and can return to the stable control again. A state in which the control can be returned to the stable state can provide the occupant or the like with “safety in case of emergency”.

In the driving system 2, the determination unit 20 may determine whether to continue the stable control or transition to a minimal risk condition (MRC) within the performance limit range R2 (in other words, before getting out of the performance limit range R2). The minimal risk condition may be a fallback condition. The determination unit 20 may determine whether to continue the stable control or transition to the minimal risk condition outside the stable-control possible range R1 and within the performance limit range R2. The transition to the minimal risk condition may be execution of the MRM or the DDT fallback.

For example, when the ODD is set within the performance limit range R2 and outside the stable-control possible range R1, the determination unit 20 may execute the MRM or the DDT fallback on condition of deviation from the ODD (ODD-exit). The MRM or the DDT fallback may be, for example, an operation of safely stopping the subject vehicle 1 on a lane of a road, at a road side, or outside the road.

For example, when the autonomous driving of the automated driving system at Level 3 is executed, the determination unit 20 may execute authority transfer to the driver, for example, takeover. When the driver takes over the driving from the automated driving system, control for executing the MRM or the DDT fallback may be adopted. Alternatively, the MRM or the DDT fallback may include a takeover request to the driver or a remote operator.

The determination unit 20 may determine a state transition of the driving action based on the situation estimated by the environment determination unit 21. The state transition of the driving action may mean a transition of the behavior of the subject vehicle 1 implemented by the driving system 2, for example, a transition between a behavior maintaining rule consistency and predictability and a reacting behavior of the subject vehicle 1 according to an external factor such as another road user. That is, the state transition of the driving action may be a transition between an action and a reaction. The determination of the state transition of the driving action may be a determination as to whether to continue the stable control or transition to the minimal risk condition. The stable control may mean control in which there is no fluctuation, sudden acceleration, sudden brake or the like in the behavior of the subject vehicle 1, or an occurrence frequency thereof is extremely low. The stable control may mean control of a level at which a human driver recognizes that the behavior of the subject vehicle 1 is stable or there is no abnormality.

The situation estimated by the environment determination unit 21, that is, the situation estimated by an electronic system may include a difference from the real world. Therefore, the performance limit in the driving system 2 may be set based on an acceptable range of the difference from the real world. In other words, a margin between the performance limit range R2 and the stable-control possible range R1 may be defined based on the difference between the situation estimated by the electronic system and the real world. Here, the difference between the situation estimated by the electronic system and the real world may be an example of the influence or error due to a disturbance.

In other words, the margin is set based on robust performance of the driving system 2 or a subsystem thereof. For example, the margin may be set so that a safe state can be maintained at a probability equal to or higher than a predetermined value set in advance based on probability distribution of a value indicating safety or a risk depending on performance assumed from a disturbance or uncertainty, a control state, or a situation.

Here, a situation used for determining the transition to the minimal risk condition may be recorded in the recording device 55 in a format estimated by the electronic system, for example. In the MRM or DDT fallback, for example, when there is interaction between the electronic system and the driver through the HMI device 70, the operation of the driver may be recorded in the recording device 55.

### <Interaction in Driving System>

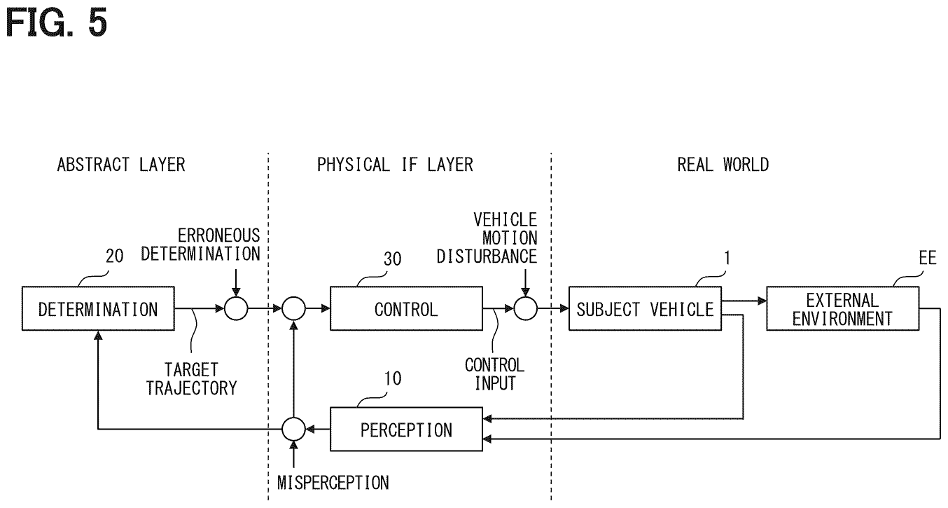

The architecture of the driving system 2 can be represented by a relationship between an abstract layer, a physical interface layer (hereinafter referred to as a physical IF layer), and the real world. Here, the abstract layer and the physical IF layer may mean layers implemented by an electronic system. As illustrated in FIG. 5, the interaction between the perception unit 10, the determination unit 20, and the control unit 30 can be expressed by a block diagram showing a causal loop.

Specifically, the subject vehicle 1 in the real world affects the external environment EE. The perception unit 10 belonging to the physical IF layer percepts the subject vehicle 1 and the external environment EE. In the perception unit 10, an error or a deviation may occur due to misperception, observation noise, a perception disturbance, or the like. The error or deviation occurring in the perception unit 10 affects the determination unit 20 belonging to the abstract layer. On the premise that the control unit 30 acquires the vehicle state for controlling the motion actuator 60, the error or deviation occurring in the perception unit 10 directly affects the control unit 30 belonging to the physical IF layer without through the determination unit 20. In the determination unit 20, an erroneous determination, a traffic disturbance, or the like may occur. An error or a deviation occurring in the determination unit 20 affects the control unit 30 belonging to the physical IF layer. When the control unit 30 controls the motion of the subject vehicle 1, a vehicle disturbance occurs. The subject vehicle 1 in the real world affects the external environment EE, and the perception unit 10 percepts the subject vehicle 1 and the external environment EE.

In this way, the driving system 2 forms a causal loop structure operating between the layers. Specifically, a causal loop structure operating between the real world, the physical IF layer, and the abstract layer is formed. Errors or deviations occurring in the perception unit 10, the determination unit 20, and the control unit 30 may propagate along the causal loop.

The causal loop is classified into an open loop and a closed loop. The open loop is, for example, a loop directly directed from the perception unit 10 to the determination unit 20 or a loop directly directed from the determination unit 20 to the control unit 30. The open loop can also be said to be a partial loop obtained by removing a part of a closed loop.

The closed loop is a loop configured to circulate between the real world and at least one of the physical IF layer and the abstract layer. The closed loop is classified into an inner loop IL that is completed in the subject vehicle 1 and an outer loop EL including interaction between the subject vehicle 1 and the external environment EE.

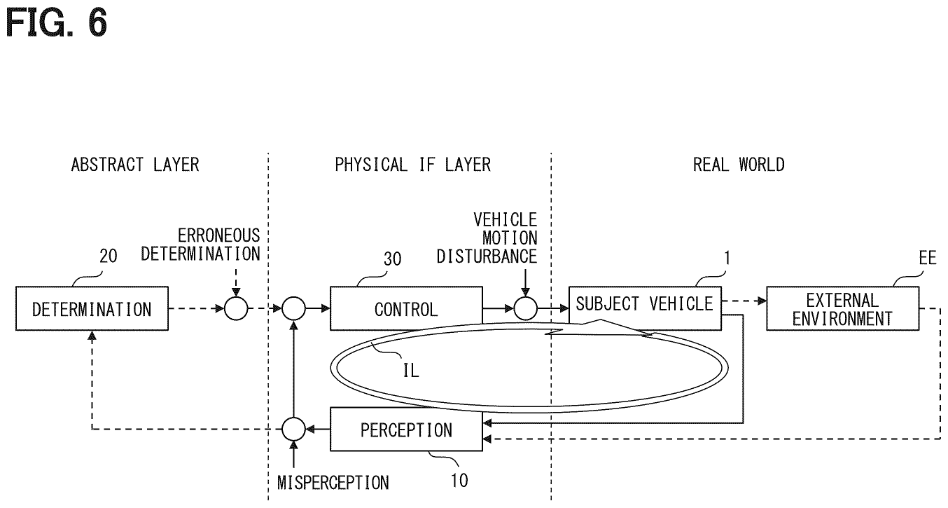

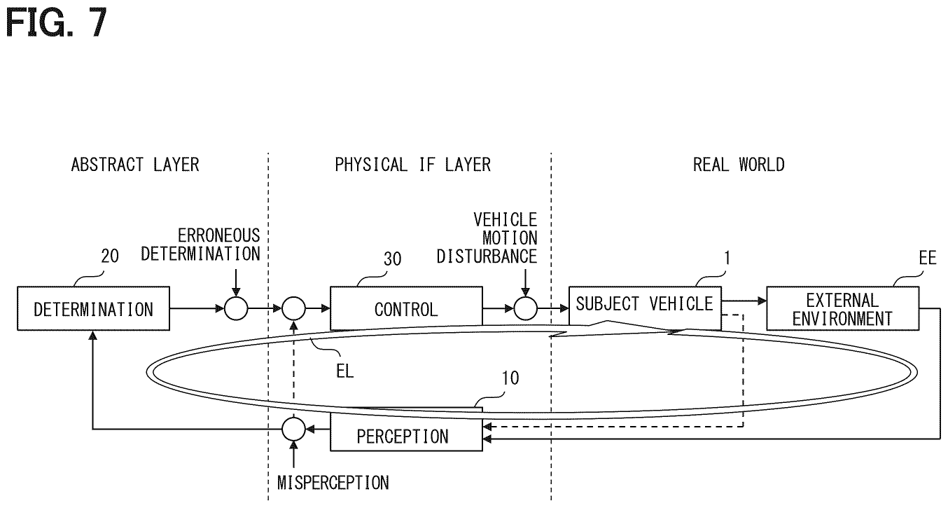

For example, in FIG. 6, the inner loop IL is a loop returning from the subject vehicle 1 to the subject vehicle 1 via the perception unit 10 and the control unit 30. As described above, parameters directly affecting the control unit 30 from the perception unit 10 are vehicle states such as the vehicle speed, the acceleration, and the yaw rate on one premise, and do not include the perception result of the external environment sensor 41, so that the inner loop IL can be said to be a loop completed in the subject vehicle 1. For example, in FIG. 7, the outer loop EL is a loop returning from the subject vehicle 1 to the subject vehicle 1 via the external environment EE, the perception unit 10, the determination unit 20, and the control unit 30.

### <Verification and Validation>

The verification and validation of the driving system 2 may include an evaluation in which at least one of the following functions and capabilities is taken as an object to be evaluated, and preferably all the functions and capabilities are taken as objects to be evaluated. The object to be evaluated herein may be referred to as an object to be verified or an object to be validated.

For example, objects to be evaluated related to the perception unit 10 are a function of a sensor or an external data source (for example, a map data source), a function of a sensor processing algorithm for modeling an environment, and reliability of infrastructure and a communication system.

For example, the object to be evaluated related to the determination unit 20 is a capability of a determination algorithm. The capability of the determination algorithm is, for example, a capability to safely handling a potential lack of functionality, and a capability to make an appropriate determination according to an environment model, a driving policy, a current destination, and the like. For example, objects to be evaluated related to the determination unit 20 are the absence of an unreasonable risk due to a hazardous behavior of an intended function, a function of a system that safely processes a use case of the ODD, robust performance of execution of a driving policy of the entire ODD, suitability for DDT fallback, and suitability for a minimal risk condition.

For example, the object to be evaluated is robust performance of a system or a function. The robust performance of a system or a function includes the robust performance of the system with respect to an adverse environmental condition, suitability of a system operation with respect to a known triggering condition, sensitivity of an intended function, a capability of monitoring various scenarios, and the like.

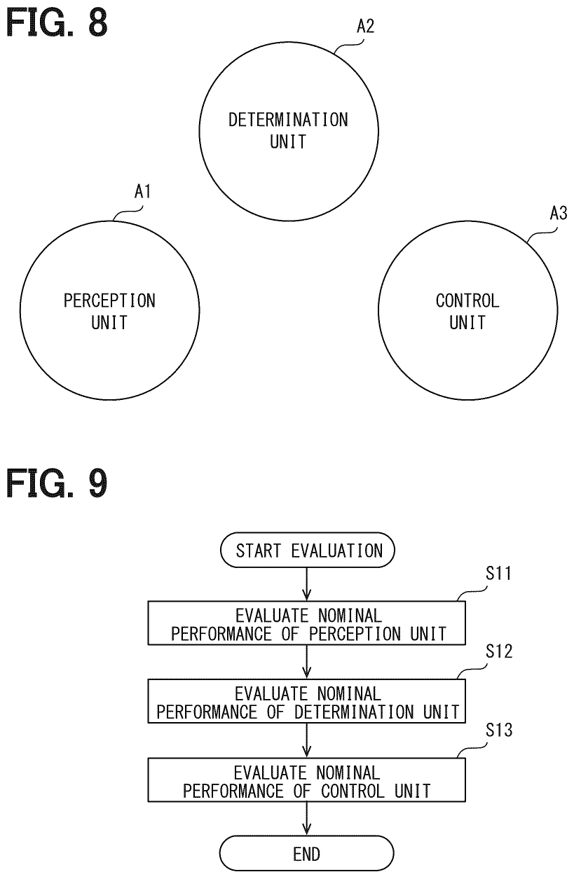

Next, several examples of the evaluation method of the driving system 2 will be specifically described with reference to FIGS. 8 to 13. The evaluation method herein may be a configuration method of the driving system 2 or a design method of the driving system 2. In FIGS. 8, 10, and 12, circles A1, A2, and A3 virtually and schematically illustrate areas in which safety cannot be maintained due to respective factors of the perception unit 10, the determination unit 20, and the control unit 30.

A first evaluation method is a method of independently evaluating the perception unit 10, the determination unit 20, and the control unit 30 as illustrated in FIG. 8. That is, the first evaluation method includes individually evaluating nominal performance of the perception unit 10, nominal performance of the determination unit 20, and nominal performance of the control unit 30. The individual evaluation may be an evaluation based on different viewpoints and means between the perception unit 10, the determination unit 20, and the control unit 30.

For example, the control unit 30 may be evaluated based on a control theory. The determination unit 20 may be evaluated based on a logical model that proves safety. The logical model may be a responsibility sensitive safety (RSS) model, a safety force field (SFF) model, or the like.

The perception unit 10 may be evaluated based on a perception failure rate. For example, an evaluation criterion may be whether the perception result of the entire perception unit 10 is equal to or less than a target perception failure rate. The target perception failure rate for the entire perception unit 10 may be a value less than a statistically calculated collision encounter rate of the human driver. The target perception failure rate may be, for example, 10-9, which is a probability of two orders lower than an accident encounter rate. Here, the perception failure rate is a value normalized to 1 in the case of 100% failure.

Further, when multiple subsystems (for example, a subsystem of the camera, a subsystem of the external environment sensor 41 excluding the camera, and a subsystem of the map) are implemented by multiple sensors 40, the reliability may be secured by majority decision of the multiple subsystems. Assuming the majority decision of the subsystems, the target perception failure rate for each subsystem may be a value greater than the target perception failure rate for the entire perception unit 10. The target perception failure rate for each subsystem may be, for example, 10-5. In the first evaluation method, a target value or a target condition may be set based on a positive risk balance.

An example of the first evaluation method will be described with reference to the flowchart in FIG. 9. An implementation subject in each step of S11 to S13 is at least one of, for example, the vehicle manufacturer, the vehicle designer, the manufacturer of the driving system 2, the designer of the driving system 2, the manufacturer of the subsystems constituting the driving system 2, the designer of the subsystem, a party commissioned by the manufacturer or designer thereof, and a testing organization or authentication organization for the driving system 2. When the evaluation is performed by simulation, at least one processor may be a substantial implementation subject. The implementation subjects in the steps S11 to S13 may be a common subject or different subjects.

In S11, the nominal performance of the perception unit 10 is evaluated. In S12, the nominal performance of the determination unit 20 is evaluated. In S13, the nominal performance of the control unit 30 is evaluated. The order of S11 to S13 can be appropriately changed, and the steps S11 to S13 can be performed simultaneously.

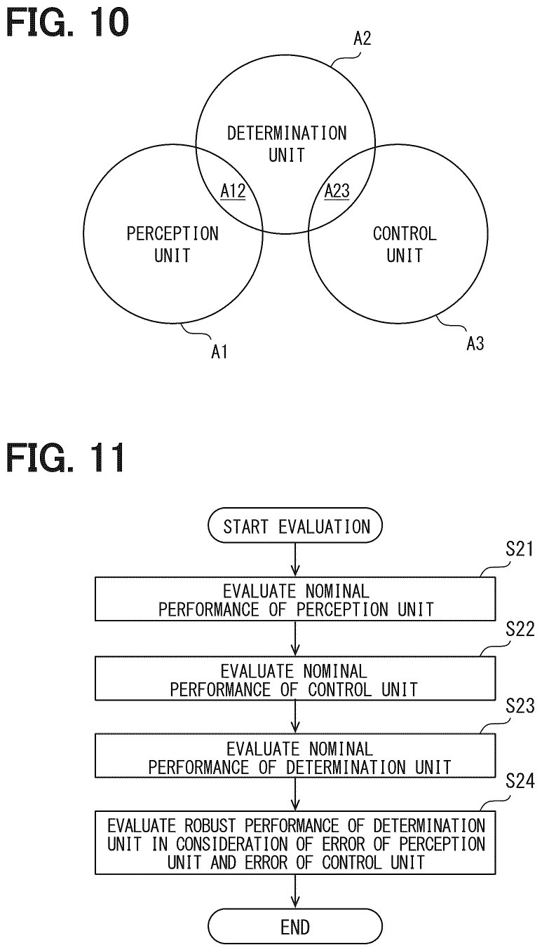

As illustrated in FIG. 10, a second evaluation method includes evaluating the nominal performance of the determination unit 20 and evaluating the robust performance of the determination unit 20 in consideration of at least one of the error of the perception unit 10 and the error of the control unit 30. As the premise of this evaluation method, the second evaluation method may further include evaluating the nominal performance of the perception unit 10 and evaluating the nominal performance of the control unit 30. The nominal performance of the determination unit 20 may be evaluated based on the above-described traffic disturbance scenario.

The robust performance of the determination unit 20 may be evaluated by verifying a traffic disturbance scenario in which an error range is specified using a physical-based error model that represents an error of the perception unit 10, such as an error of a sensor. For example, a traffic disturbance scenario under an environmental condition in which a perception disturbance has occurred is evaluated. Accordingly, in the second evaluation method, an area A12 where the circle A1 of the perception unit 10 and the circle A2 of the determination unit 20 overlap each other as illustrated in FIG. 10, in other words, a composite factor of the perception unit 10 and the determination unit 20 may be included in the object to be evaluated. The evaluation of the composite factor of the perception unit 10 and the determination unit 20 may be implemented by an evaluation of an open loop directly directed from the perception unit 10 to the determination unit 20 in the causal loop described above.

The robust performance of the determination unit 20 may be evaluated by verifying a traffic disturbance scenario in which an error range is specified using a physical-based error model that represents an error of the control unit 30, such as an error of a vehicle motion. For example, a traffic disturbance scenario under an environmental condition in which a vehicle disturbance has occurred is evaluated. Accordingly, in the second evaluation method, an area A23 where the circle A2 of the determination unit 20 and the circle A3 of the control unit 30 overlap each other as illustrated in FIG. 10, in other words, a composite factor of the determination unit 20 and the control unit 30 may be included in the object to be evaluated. The evaluation of the composite factor of the determination unit 20 and the control unit 30 may be implemented by an evaluation of an open loop directly directed from the determination unit 20 to the control unit 30 in the causal loop described above.

An example of the second evaluation method will be described with reference to the flowchart of FIG. 11. An implementation subject of steps S21 to S24 is at least one of, for example, the vehicle manufacturer, the vehicle designer, the manufacturer of the driving system 2, the designer of the driving system 2, the manufacturer of the subsystems constituting the driving system 2, the designer of the subsystem, a party commissioned by the manufacturer or designer thereof, and a testing organization or authentication organization for the driving system 2. When the evaluation is performed by simulation, at least one processor may be a substantial implementation subject. The implementation subject in the steps S21 to S24 may be a common subject or different subjects.

In S21, the nominal performance of the perception unit 10 is evaluated. In S22, the nominal performance of the control unit 30 is evaluated. In S23, the nominal performance of the determination unit 20 is evaluated. In S24, the robust performance of the determination unit 20 is evaluated in consideration of the error of the perception unit 10 and the error of the control unit 30. The order of S21 to S24 can be appropriately changed, and the steps S21 to S14 can be performed simultaneously.

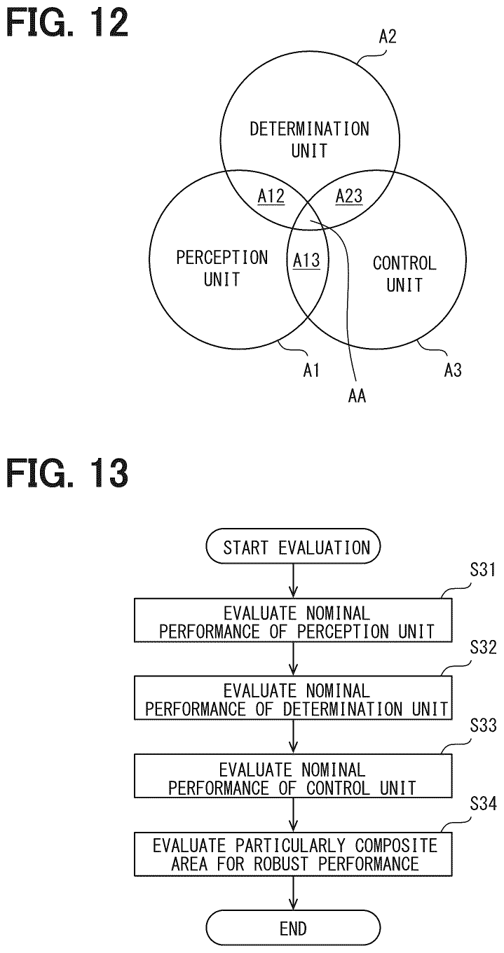

As illustrated in FIG. 12, a third evaluation method includes, as the objects to be evaluated, areas A12, A23, A13, and AA where at least two of the circle A1 of the perception unit 10, the circle A2 of the determination unit 20, and the circle A3 of the control unit 30 overlap. The third evaluation method first includes evaluating the nominal performance of the perception unit 10, the nominal performance of the determination unit 20, and the nominal performance of the control unit 30. In evaluating the nominal performance, the first evaluation method may be adopted, or a part of the first evaluation method may be adopted. On the other hand, in evaluating the nominal performance, a method completely different from the first evaluation method may be adopted.

Further, the third evaluation method includes evaluating particularly a composite factor in which at least two of the perception unit 10, the determination unit 20, and the control unit 30 are combined, regarding the robust performance of the perception unit 10, the robust performance of the determination unit 20, and the robust performance of the control unit 30. Here, a composite factor of at least two of the perception unit 10, the determination unit 20, and the control unit 30 includes a composite factor of the perception unit 10 and the determination unit 20, a composite factor of the determination unit 20 and the control unit 30, a composite factor of the perception unit 10 and the control unit 30, and a composite factor of three, that is, the perception unit 10, the determination unit 20, and the control unit 30.

Evaluating particularly a composite factor may be, for example, extracting a specific condition under which the interaction between the perception unit 10, the determination unit 20, and the control unit 30 is relatively large based on a scenario, and evaluating the specific condition in more detail than another condition under which the interaction is relatively small. The evaluating in more detail may include at least one of evaluating the specific condition in more detail than another condition and evaluating the specific condition by increasing the number of tests. The conditions to be evaluated (for example, the above-described specific condition and other conditions) may include a triggering condition. Here, the magnitude of the interaction may be specified using the causal loop described above.

Some of the evaluation methods described above may include defining an object to be evaluated, designing a test plan based on the definition of the object to be evaluated, and executing the test plan to indicate absence of an unreasonable risk caused by a known or unknown hazardous scenario. The test may be any of a physical test, a simulation test, and a combination of the physical test and the simulation test. The physical test may be, for example, a field operational test (FOT). A target value in the FOT may be set in a form of the number of failures allowed for a predetermined travel distance (for example, tens of thousands km) of a test vehicle using FOT data or the like.

An example of the third evaluation method will be described with reference to the flowchart of FIG. 13. An implementation subject of steps S31 to S34 is at least one of, for example, the vehicle manufacturer, the vehicle designer, the manufacturer of the driving system 2, the designer of the driving system 2, the manufacturer of the subsystems constituting the driving system 2, the designer of the subsystem, a party commissioned by the manufacturer or designer thereof, and a testing organization or authentication organization for the driving system 2. When the evaluation is performed by simulation, at least one processor may be a substantial implementation subject. The implementation subject in the steps S31 to S34 may be a common subject or different subjects.

In S31, the nominal performance of the perception unit 10 is evaluated. In S32, the nominal performance of the determination unit 20 is evaluated. In S33, the nominal performance of the control unit 30 is evaluated. In S34, composite areas A12, A23, A13, and AA are particularly evaluated for the robust performance. The order of S31 to S34 can be appropriately changed, and the steps S31 to S34 can be performed simultaneously.

Here, the nominal performance in the present embodiment may be performance exhibited at the time of nominal operation as designed of the driving system 2 or the subsystem thereof. The nominal performance may be a maximum value of performance that can be exhibited in design of the driving system 2 or the subsystem thereof.

The robust performance in the present embodiment may be performance that can be exhibited by the driving system 2 or the subsystem thereof under the influence of a disturbance. The robust performance may be performance that can be exhibited under the influence of performance degradation with respect to uncertainty. The uncertainty herein may include uncertainty of the external environment in the environment model. That is, the uncertainty of another road user, another vehicle equipped with an automated driving system, or the like may be included. The uncertainty may include uncertainty related to the contribution of a rare phenomenon that is not considered in design.

### <Control Switching and Control Action>

Hereinafter, control switching and control actions executed by the driving system 2 during traveling of the subject vehicle 1 will be described in detail. Here, the subject vehicle 1 during traveling may mean the so-called autonomous driving of Level 3 or higher in execution, or may mean the so-called manual driving of Levels 0 to 2 in execution or the driving support in execution. The execution of a best effort described later in the state of Levels 0 to 2 may be accompanied by transfer of the authority to execute the dynamic driving task from the driver to the driving system 2.

The control switching may be a control behavior of the driving system 2 that changes at least one of a control processing method and the nominal performance during traveling of the subject vehicle 1. The control action is a behavior of executing the control switching according to a determination based on the situation estimated by the driving system 2 or a behavior of continuing the control without executing the switching. The determination may include a response to a change in the situation due to an external factor such as another road user. The subject vehicle 1 behaves in reaction to a situation by the control action.

A relationship between the control state and the control switching can be set, for example, according to an evaluation and analysis result of the scenario in the verification and validation of the driving system 2. The relationship between the control state and the control switching may be referred to as a switching condition. The switching condition may include a minimal risk condition or a fallback condition.

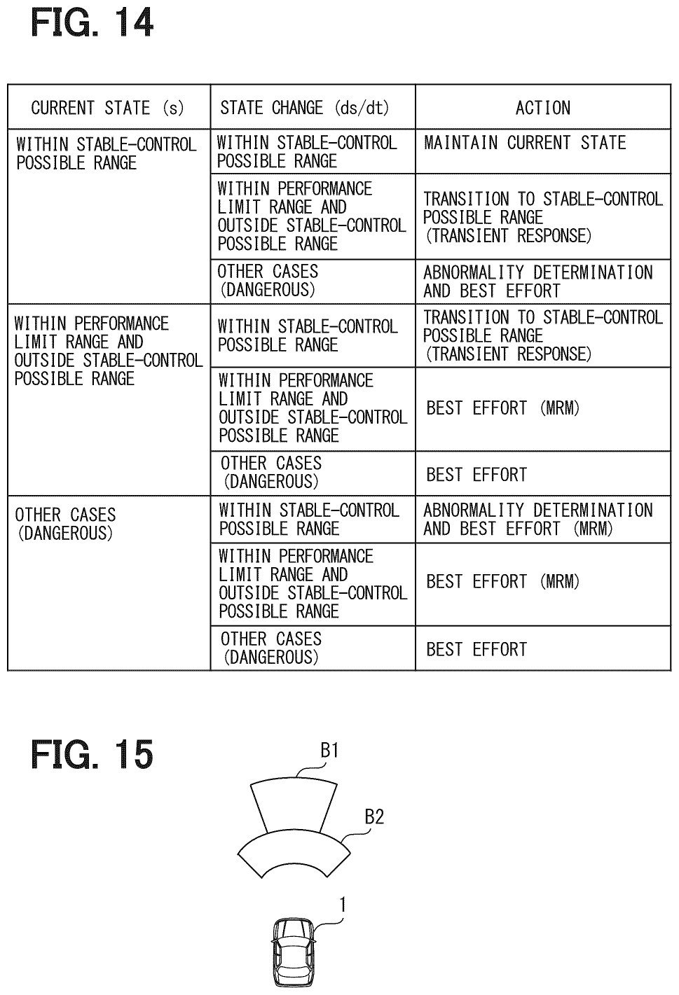

FIG. 14 illustrates an example of a relationship between a state parameter indicating a current control state (hereinafter, referred to as a current state), a state change parameter indicating a state change of the control state, and a control action. The state change of s which is the state parameter may be a differential ds/dt depending on the time t of s. When s is a discrete state parameter, a condition determining the next state of s may be the state change parameter of s. That is, the acquisition of the state change by the driving system 2 may be acquisition of a continuous state change or acquisition of a discrete state change.

For example, when s is a distance between the subject vehicle 1 and another vehicle, ds/dt is a relative speed of the subject vehicle 1 with respect to the other vehicle. For example, when s is the speed of the subject vehicle 1, ds/dt is the acceleration of the subject vehicle 1. For example, when s is a yaw angle of the subject vehicle 1, ds/dt is the yaw rate of the subject vehicle 1.

In the driving system 2, the stable-control possible range R1 and the performance limit range R2 may be defined for each of multiple parameters. The multiple parameters may include the state parameter and the state change parameter described above. The stable-control possible range R1 and the performance limit range R2 for each parameter may be defined based on a driving policy based on a combination of multiple parameters. The stable-control possible range R1 and the performance limit range R2 of each parameter may be defined in a form in which the most appropriate driving policy is applied to the parameter.

A part or all of the multiple parameters to be determined may be physical values that can be sensed by the perception unit 10. Another part of the multiple parameters may be a parameter that can be calculated based on a physical value.

On the other hand, an overall control state of the subject vehicle 1 (hereinafter, abbreviated as an overall control state) may be defined for the driving system 2. The stable-control possible range R1 and the performance limit range R2 may be defined for the overall control state. The definitions of the stable-control possible range R1 and the performance limit range R2 for the overall control state may be associated with the stable-control possible range R1 and the performance limit range R2 of a part or all of multiple parameters for which the stable-control possible range R1 and the performance limit range R2 are individually defined.

The driving system 2 may determine whether each parameter is within or outside the stable-control possible range R1. The driving system 2 may determine whether each parameter is within or outside the performance limit range R2.

As a determination for the overall control state of the subject vehicle 1, the driving system 2 may determine whether the control state is within or outside the stable-control possible range R1. As a determination for the overall control state of the subject vehicle 1, the driving system 2 may determine whether the control state is within or outside the performance limit range R2. As a determination for the change in the overall control state of the subject vehicle 1, the driving system 2 may determine whether the change in the control state is within or outside the stable-control possible range R1. As a determination for the change in the overall control state of the subject vehicle 1, the driving system 2 may determine whether the change in the control state is within or outside the performance limit range R2.

FIG. 15 schematically illustrates a relationship between a relative position of an obstacle and the performance limit range R2 and the stable-control possible range R1 when the parameter to be determined is the relative position of the obstacle with respect to the subject vehicle 1. Here, it is assumed that the subject vehicle 1 travels forward at a predetermined speed and acceleration. For example, when an obstacle is present in a partial cylindrical area B1 in front of the subject vehicle 1, a range indicating the control state with respect to the relative position of the obstacle is within the performance limit range R2 and outside the stable-control possible range R1. When the obstacle is present in an area B2 that is a partial cylindrical or fan-shaped area in front of the subject vehicle 1 and includes an area between the subject vehicle 1 and the area B1, the range indicating the control state with respect to the relative position of the obstacle is outside the performance limit range R2.

Here, the area B1 and the area B2 have a relationship in which an inner peripheral portion of the area B1 is in contact with an outer peripheral portion of the area B2. Further, typically, a central angle (or a width in the lateral direction) of the area B2 may be larger than a central angle (or a width in the lateral direction) of the area B1. The area B1 may substantially mean an area in which a collision with an obstacle can be avoided with unstable control. The area B2 may substantially mean an area in which a collision with an obstacle cannot be avoided.

The driving system 2 may derive the control action based on the state parameter for which the above-described range is determined and the state change parameter for which the above-described range is determined. In other words, the driving system 2 may derive the control action according to the determination result of the range for the state parameter and the determination result of the range for the state change parameter. Here, the control action may be an action intended to cause only the state parameter to be determined to make a state transition, or may be an action that affects other state parameters.

The driving system 2 may derive the control action according to the determination result of the range for the overall control state of the subject vehicle 1 and the determination result of the range for the change in the overall control state.

Specifically, when the current state is within the stable-control possible range R1 and the state change is within the stable-control possible range R1, the driving system 2 may derive a control action for maintaining the current state.

When the current state is within the stable-control possible range R1 and the state change is within the performance limit range R2 and outside the stable-control possible range R1, the driving system 2 may derive a control action for transitioning the state change to target control in the stable-control possible range R1. This control action may be referred to as a transient response. The transient response may mean a response in the middle of switching control. The transient response may be a response to return the control from a safe and unstable state to a stable state. The transient response may be an aspect of a so-called proper response.

The driving system 2 may set a limit value for condition switching in the transient response. When it is assumed that the limit value is exceeded before the execution of the transient response, the driving system 2 may cancel the execution of the transient response and derive a control action for executing a best effort. When it is assumed that the limit value is exceeded during the execution of the transient response, the driving system 2 may cancel the execution of the transient response and derive a control action for executing a best effort. When the limit value is exceeded during the execution of the transient response, the driving system 2 may cancel the execution of the transient response and derive a control action for executing the best effort.

Here, the best effort is typically a best effort capable of guaranteeing a minimal risk, for example, the MRM or the DDT fallback. However, the derivation of the control action here may include determining whether a best effort capable of guaranteeing a minimal risk is executable, for example, the MRM or the DDT fallback. When it is determined that the best effort capable of guaranteeing the minimal risk is executable, the derivation of the control action may include deriving the control action for executing the best effort. When it is determined that the best effort capable of guaranteeing the minimal risk is not executable, the derivation of the control action may include deriving a control action for executing a best effort that is incapable of guaranteeing the minimal risk.

When the current state is within the stable-control possible range R1 and the state change is outside the performance limit range R2, the driving system 2 may derive a control action for executing a best effort. When the current state is within the stable-control possible range R1 and the state change is undeterminable, the driving system 2 may derive a control action for executing a best effort.

In these cases, the driving system 2 may determine that the driving system 2 has an abnormality (hereinafter, referred to as abnormality determination). Here, the abnormality may mean that an impossible state change in design of the driving system 2 has occurred. The abnormality may be caused by the occurrence of an unknown hazardous scenario.

Here, the best effort is typically a best effort incapable of guaranteeing a minimal risk. On the other hand, the derivation of the control action here may include determining whether the best effort capable of guaranteeing a minimal risk is executable, for example, the MRM or the DDT fallback. When it is determined that the best effort capable of guaranteeing the minimal risk is executable, the derivation of the control action may include deriving the control action for executing the best effort. When it is determined that the best effort capable of guaranteeing the minimal risk is not executable, the derivation of the control action may include deriving a control action for executing a best effort that is incapable of guaranteeing the minimal risk.

When the current state is within the performance limit range R2 and outside the stable-control possible range R1 and the state change is within the stable-control possible range R1, the driving system 2 may derive a control action for transitioning the current state to control in the stable-control possible range R1. This control action may be referred to as a transient response.

When the current state is within the performance limit range R2 and outside the stable-control possible range R1 and the state change is within the performance limit range R2 and outside the stable-control possible range R1, the driving system 2 may derive a control action for executing a best effort. Here, the best effort is typically a best effort capable of guaranteeing a minimal risk, for example, the MRM or the DDT fallback.

When the current state is within the performance limit range R2 and outside the stable-control possible range R1 and the state change is outside the performance limit range R2, the driving system 2 may derive a control action for executing a best effort. When the current state is within the performance limit range R2 and outside the stable-control possible range R1 and the state change is undeterminable, the driving system 2 may derive a control action for executing a best effort.

Here, the best effort is typically a best effort incapable of guaranteeing a minimal risk. On the other hand, the derivation of the control action here may include determining whether the best effort capable of guaranteeing a minimal risk is executable, for example, the MRM or the DDT fallback. When it is determined that the best effort capable of guaranteeing the minimal risk is executable, the derivation of the control action may include deriving the control action for executing the best effort. When it is determined that the best effort capable of guaranteeing the minimal risk is not executable, the derivation of the control action may include deriving a control action for executing a best effort that is incapable of guaranteeing the minimal risk.

When the current state is outside the performance limit range R2 and the state change is within the stable-control possible range R1, the driving system 2 may derive a control action for executing a best effort. When the current state is undeterminable and the state change is outside the stable-control possible range R1, the driving system 2 may derive a control action for executing a best effort. In these cases, the driving system 2 may make an abnormality determination.

Here, the best effort is typically a best effort capable of guaranteeing a minimal risk, for example, the MRM or the DDT fallback. However, the derivation of the control action here may include determining whether a best effort capable of guaranteeing a minimal risk is executable, for example, the MRM or the DDT fallback. When it is determined that the best effort capable of guaranteeing the minimal risk is executable, the derivation of the control action may include deriving the control action for executing the best effort. When it is determined that the best effort capable of guaranteeing the minimal risk is not executable, the derivation of the control action may include deriving a control action for executing a best effort that is incapable of guaranteeing the minimal risk.

When the current state is outside the performance limit range R2 and the state change is within the performance limit range R2 and outside the stable-control possible range R1, the driving system 2 may derive a control action for executing a best effort. When the current state is undeterminable and the state change is within the performance limit range R2 and outside the stable-control possible range R1, the driving system 2 may derive a control action for executing a best effort. In these cases, the driving system 2 may make an abnormality determination.

Here, the best effort is typically a best effort capable of guaranteeing a minimal risk, for example, the MRM or the DDT fallback. However, the derivation of the control action here may include determining whether a best effort capable of guaranteeing a minimal risk is executable, for example, the MRM or the DDT fallback. When it is determined that the best effort capable of guaranteeing the minimal risk is executable, the derivation of the control action may include deriving the control action for executing the best effort. When it is determined that the best effort capable of guaranteeing the minimal risk is not executable, the derivation of the control action may include deriving a control action for executing a best effort that is incapable of guaranteeing the minimal risk.

When the current state is outside the performance limit range R2 and the state change is outside the performance limit range R2, the driving system 2 may derive a control action for executing a best effort. When the current state is undeterminable and the state change is outside the performance limit range R2, the driving system 2 may derive a control action for executing a best effort. When the current state is outside the performance limit range R2 and the state change is undeterminable, the driving system 2 may derive a control action for executing a best effort. When the current state is undeterminable and the state change is undeterminable, the driving system 2 may derive a control action for executing a best effort. In these cases, the driving system 2 may make an abnormality determination.

Here, the best effort is typically a best effort incapable of guaranteeing a minimal risk. On the other hand, the derivation of the control action here may include determining whether the best effort capable of guaranteeing a minimal risk is executable, for example, the MRM or the DDT fallback. When it is determined that the best effort capable of guaranteeing the minimal risk is executable, the derivation of the control action may include deriving the control action for executing the best effort. When it is determined that the best effort capable of guaranteeing the minimal risk is not executable, the derivation of the control action may include deriving a control action for executing a best effort that is incapable of guaranteeing the minimal risk.

The switching of the control and the derivation of the control action based on the switching can be executed by, for example, the determination unit 20. The switching of the control may be included in the behavior plan made by the driving planning unit 22, for example. The switching of the control may be included in the restriction on the function set by the mode management unit 23.

For example, as an on-board implementation strategy, the mode management unit 23 itself or the function of setting a restriction in the mode management unit 23 may be implemented by the dedicated computer 51 (for example, SoC) that includes at least one processor, a memory, and an interface. In this case, the SoC acquires information on the stability of the behavior of the subject vehicle 1 through the interface. The information on the stability of the behavior of the subject vehicle 1 may be, for example, information perceived by the perception unit 10 or a situation estimated by the environment determination unit 21. The SoC sets a restriction for the driving system 2 to switch the control, according to the information on the stability of the behavior of the subject vehicle 1. In order to set the restriction, the SoC may determine the range as described above based on, for example, the performance limit range R2 and the stable-control possible range R1 stored in the memory 51a. The SoC outputs the set restriction to, for example, the driving planning unit 22 (or directly to the motion control unit 31) through the interface.

### <Recording>

Recording of information in the recording device 55 accompanying switching of the control action will be described below.

The recording device 55 may execute recording based on a fact that a condition such as a switching condition, a triggering condition, a minimal risk condition, or a fallback condition is satisfied, a fact that a control action for executing a best effort is derived, or a fact that the best effort is actually executed. The recording device 55 may execute the recording based on a fact that a control action for executing a transient response is derived or a fact that the transient response is actually executed.

In the execution of this recording, the recording device 55 records, as a set, information on the derived control action and information used for determination of control action derivation. The set of records may further include at least one of a time stamp, a vehicle state, sensor abnormality (or sensor failure) information, abnormality determination information, and the like.

For example, when the driving system 2 executes the MRM, the recording device 55 may record execution information of the MRM as information on the derived control action. The recording device 55 may record, as the information used for the determination of the control action derivation, a situation estimated by the driving system 2 and information indicating which range the control state is in determined by the driving system 2 based on the situation.

The information indicating which range the control state is in is information for distinguishing whether the control state is within the stable-control possible range R1, within the performance limit range R2 and outside the stable-control possible range R1, or outside the performance limit range R2. The information indicating which range the control state is in may be a combination of information indicating whether the control state is within or outside the performance limit range R2 and information indicating whether the control state is within or outside the stable-control possible range R1.

The information indicating which range the control state is in may include information on the overall control state. The information indicating which range the control state is in may include individual information for multiple parameters to be determined. The information indicating which range the control state is in may include information on the state parameter and information on the state change parameter. The above information to be recorded may be encrypted or hashed.

### <Example of Operation Flow>

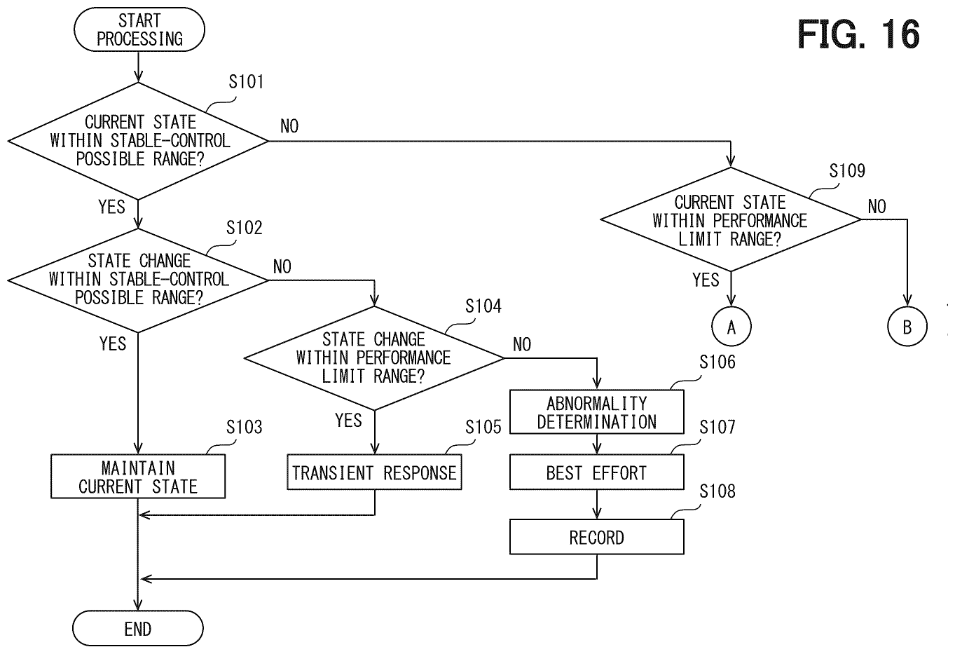

Hereinafter, an example of processing related to switching of the control action in an operation flow of the driving system 2 will be described with reference to flowcharts in FIGS. 16 to 18. A series of processing shown in steps S101 to S127 is repeatedly executed by the driving system 2 at predetermined time intervals or based on a predetermined trigger according to a program stored in the memory 51a, for example.

First, in S101 illustrated in FIG. 16, the determination unit 20 determines whether the current state is within the stable-control possible range R1. If an affirmative determination is made in S101, the process proceeds to S102. If a negative determination is made in S101, the process proceeds to S109.

In S102, the determination unit 20 determines whether the state change is within the stable-control possible range R1. If an affirmative determination is made in S102, the process proceeds to S103. If a negative determination is made in S102, the process proceeds to S104.

In S103, the determination unit 20 derives a control action to maintain the current state. The series of processing ends at S103.

In S104, the determination unit 20 determines whether the state change is within the performance limit range R2. If an affirmative determination is made in S104, the process proceeds to S105. If a negative determination is made in S104, the process proceeds to S106.

In S105, the determination unit 20 derives a control action for executing a transient response. The series of processing ends at S105.

In S106, the determination unit 20 makes an abnormality determination. In S107 after the processing of S106, the determination unit 20 derives a control action for executing a best effort. In S108 after the processing of S107, the recording device 55 records, as a set, information on the derived control action and information used for determination of the control action derivation. The series of processing ends at S108.

In S109, the determination unit 20 determines whether the current state is within the performance limit range R2. If an affirmative determination is made in S109, the process proceeds to S111. If a negative determination is made in S109, the process proceeds to S121.

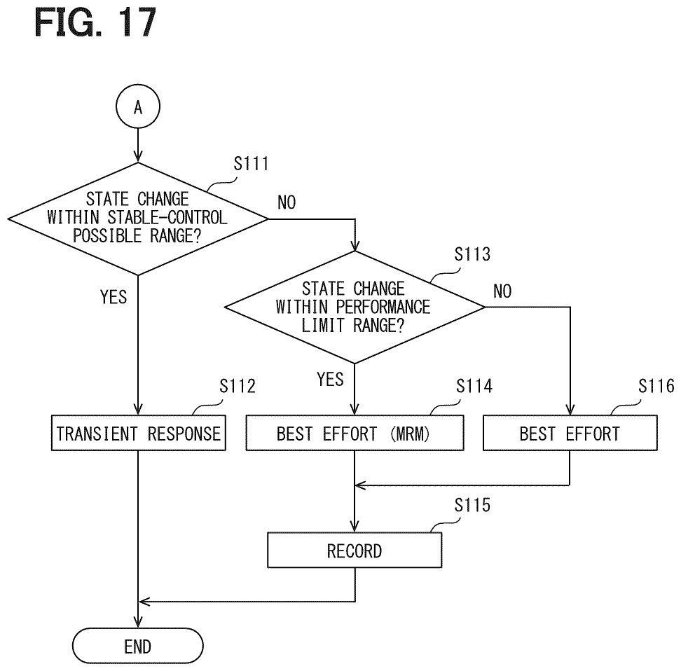

In S111 illustrated in FIG. 17, the determination unit 20 determines whether the state change is within the stable-control possible range R1. If an affirmative determination is made in S111, the process proceeds to S112. If a negative determination is made in S111, the process proceeds to S113.

In S112, the determination unit 20 derives a control action for executing the transient response. The series of processing ends at S112.

In S113, the determination unit 20 determines whether the state change is within the performance limit range R2. If an affirmative determination is made in S113, the process proceeds to S114. If a negative determination is made in S114, the process proceeds to S116.

In S114, the determination unit 20 derives a control action for executing a best effort (for example, the MRM). In S115 after the processing of S114, the recording device 55 records, as a set, information on the derived control action and information used for determination of the control action derivation. The series of processing ends at S115.

In S116, the determination unit 20 derives a control action for executing a best effort. After the processing of S116, the process proceeds to S115.

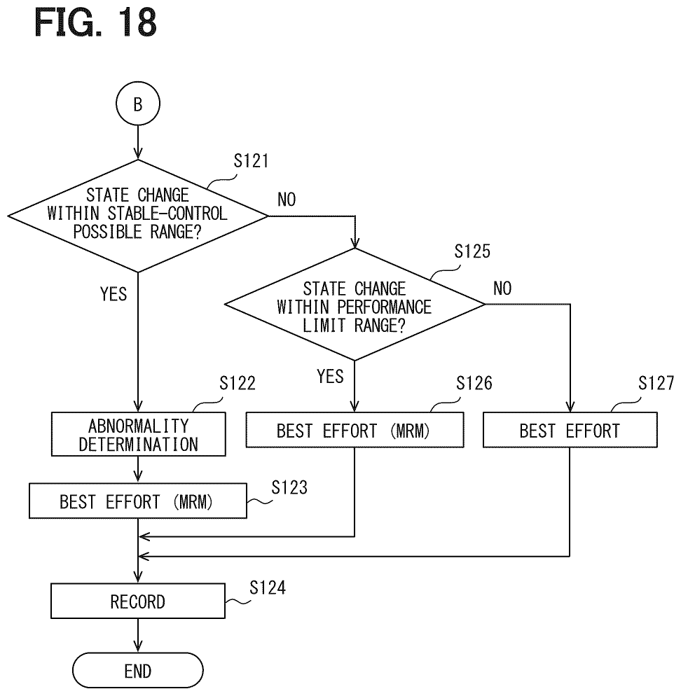

In S121 illustrated in FIG. 18, the determination unit 20 determines whether the state change is within the stable-control possible range R1. If an affirmative determination is made in S121, the process proceeds to S122. If a negative determination is made in S121, the process proceeds to S125.

In S122, the determination unit 20 makes an abnormality determination.

In S123 after the processing of S122, the determination unit 20 derives a control action for executing a best effort. In S124 after the processing of S123, the recording device 55 records, as a set, information on the derived control action and information used for determination of the control action derivation. The series of processing ends at S124.

In S125, the determination unit 20 determines whether the state change is within the performance limit range R2. If an affirmative determination is made in S125, the process proceeds to S126. If a negative determination is made in S125, the process proceeds to S127.

In S126, the determination unit 20 derives a control action for executing a best effort (for example, the MRM). After the processing of S126, the process proceeds to S124.

In S127, the determination unit 20 derives a control action for executing a best effort. After the processing of S127, the process proceeds to S124.

### <Operation and Effects>

The operation and effects of the first embodiment described above will be described below.

According to the first embodiment, the control action of the subject vehicle 1 is derived according to the determination as to whether the control state is within the stable-control possible range R1. The stable-control possible range R1 is associated with the performance limit range R2 and is defined as a range in which stable control can be maintained within the performance limit range R2. That is, the control action is derived from the viewpoint of whether the driving system 2 can maintain stable control in consideration of the performance limit. Since it is also possible to switch the control action before the performance limit is reached, a strong sense of security can be given to the occupant.

According to the first embodiment, the determination as to whether the control state is within the stable-control possible range R1 is executed based on a perceived situation, and the control action is derived as a reaction to the perceived situation. Accordingly, the control action as a reaction in the case where the situation changes due to an external factor such as another road user can be switched before the performance limit is reached. Therefore, the occupant can be given a strong sense of security.

According to the first embodiment, the switching of the control action is based on the switching condition set according to the determination result of whether the control state is within the stable-control possible range R1, is within the performance limit range R2 and outside the stable-control possible range R1, or is outside the performance limit range R2. A different control action is derived according to whether a stable state can be maintained, whether performance of returning to a stable state can be exhibited even in case of an unstable state, or whether it is not possible to return to a stable state. By switching in consideration of the control stability, a strong sense of security can be given to the occupant.

According to the first embodiment, when the control state is outside the performance limit range R2, a best effort is executed. Since the risk can be minimized within control capacity by the best effort, the validity of the control action to be executed can be enhanced.

According to the first embodiment, the parameters to be determined in the stable-control possible range R1 include the state parameter indicating the current state of the control state and the state change parameter indicating the state change of the control state. By determining both the current state and the state change, the predictability of the control state in the determination can be improved. Therefore, the validity of the control action to be executed can be enhanced.

According to the first embodiment, the setting of the performance limit range R2 and the stable-control possible range R1 is based on a difference between the situation estimated by the processor and the real world. Since the difference is reflected in the derivation of the control action, occurrence of an erroneous determination due to an estimation error is restricted. Therefore, the occupant can be given a strong sense of security.

According to the first embodiment, information indicating which range the control state is in is recorded. Since this information is information determined based on the situation estimated by the driving system 2, an estimation result or a determination result by the driving system 2 at the time when the MRM is executed can be easily subjected to follow-up verification.

According to the first embodiment, the ODD may be set within the performance limit range R2 and outside the stable-control possible range R1. Since the ODD is outside the stable-control possible range R1, it is possible to restrict the occurrence of an excessive response in the case of deviation from the ODD, thereby improving the practicability of the driving system 2. Since the ODD is within the performance limit range R2 and outside the stable-control possible range R1, a stepwise response using the robust performance exhibited in the margin between the ranges R1 and R2 can be performed, and a success rate of succeeding in giving a response before entering a hazardous situation can be increased. Therefore, the occupant can be given a strong sense of security. The ODD of the driving system 2 may be clearly set in advance by, for example, a specification, an instruction manual, compliance with a standard specification, or another method.

### Second Embodiment

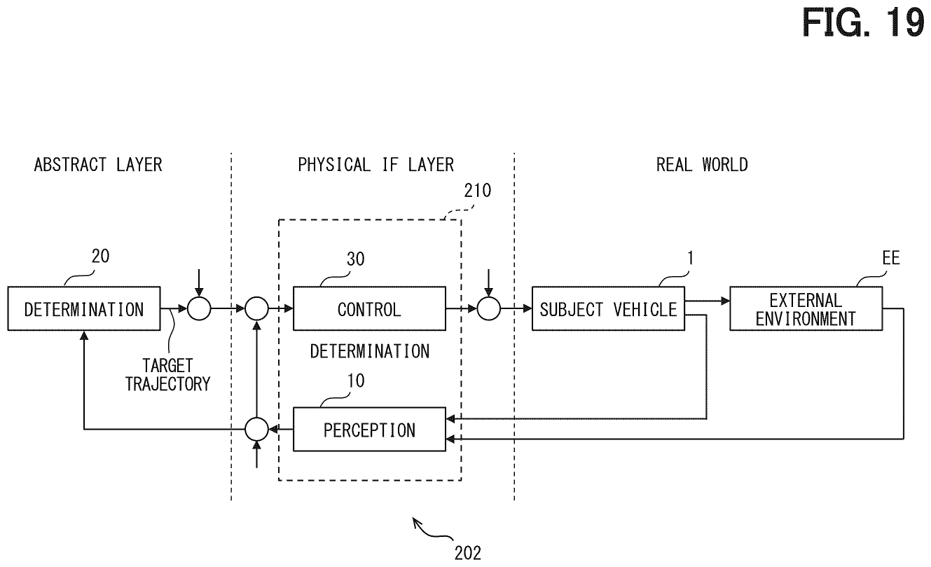

As illustrated in FIGS. 19 to 21, a second embodiment is a modification of the first embodiment. The second embodiment will be described focusing on differences from the first embodiment.

### <Recognition Control Subsystem>

As illustrated in FIG. 19, for the determination unit 20 belonging to an abstract layer, the control unit 30 and the perception unit 10 belong to a physical IF layer. Accordingly, the control unit 30 and the perception unit 10 can be regarded or implemented as one component (hereinafter, a perception control subsystem 210).

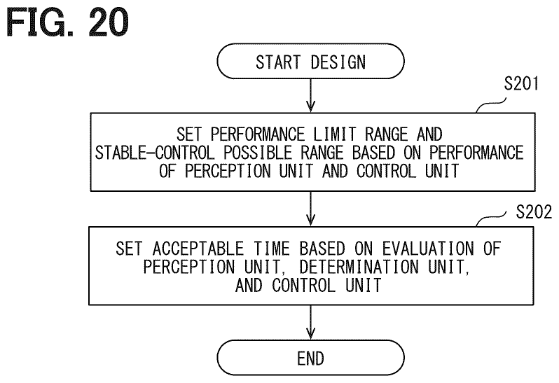

A method of setting the performance limit range R2 and the stable-control possible range R1 according to such a concept and a method of setting an acceptable time associated therewith will be described in detail below with reference to the flowchart in FIG. 20. The setting methods can be used as design methods of a driving system 202. An implementation subject in each step of S201 and S202 is at least one of, for example, the designer of the vehicle, the designer of the driving system 202, the designer of subsystems constituting the driving system 202, and a party commissioned by the manufacturer or designer of the vehicle, the driving system 202, and the subsystem. The design may be automated and implemented by at least one processor. The implementation subject in the steps may be a common subject or different subjects.

A series of design flow may be performed as setting of the performance limit range R2 and the stable-control possible range R1 for an overall control state used for switching a control action. Further, a series of design flow may be performed as setting of individual performance limit range R2 and stable-control possible range R1 for multiple parameters used for switching the control action.

First, in S201, the performance limit range R2 and the stable-control possible range R1 are set based on performance of the perception unit 10 and the control unit 30. Here, the performance of the perception unit 10 and the control unit 30 may mean performance of the perception control subsystem 210. The performance of the perception unit 10 and the control unit 30 may include nominal performance of the perception unit 10 and the control unit 30 and robust performance of the perception unit 10 and the control unit 30.

A state in which the nominal performance of the perception unit 10 and the control unit 30 is exhibited is a stable state. That is, the stable-control possible range R1 may be set according to the nominal performance of the perception unit 10 and the control unit 30. Meanwhile, when the robust performance of the perception unit 10 and the control unit 30 is exhibited, a safe state can be maintained in the driving system 202. That is, the performance limit range R2 may be set according to the robust performance of the perception unit 10 and the control unit 30. The robust performance of the perception unit 10 and the control unit 30 may be verified by evaluating an open loop directly directed from the perception unit 10 to the control unit 30. After S201, the process proceeds to S202.

In S202, the acceptable time is set based on the evaluation of the perception unit 10, the determination unit 20, and the control unit 30. Here, the acceptable time may be a time for which continuation of a state in which the control state is outside the stable-control possible range R1 is allowed. The acceptable time may be a time for which continuation of a state in which the control state is within the performance limit range R2 and outside the stable-control possible range R1 is allowed. The acceptable time may be set in common to the overall control state and all parameters, or may be set individually therefor. Instead of the acceptable time, an acceptable number of times that execution of the control action is allowed may be set.

The acceptable time may be set as a constant that does not change at all times, or may be set as a function that changes dynamically. When the acceptable time for a certain parameter is a function that dynamically changes, the function may be a function of a value of another parameter.

The evaluation of the perception unit 10, the determination unit 20, and the control unit 30 in S202 may be the evaluation of S24 illustrated in FIG. 11 or an evaluation based thereon. That is, the evaluation of the perception unit 10, the determination unit 20, and the control unit 30 may be a combination of an evaluation of an open loop directly directed from the perception unit 10 to the determination unit 20 and an evaluation of an open loop directly directed from the determination unit 20 to the control unit 30.

On the other hand, the evaluation of the perception unit 10, the determination unit 20, and the control unit 30 in S202 may be the evaluation in S34 illustrated in FIG. 13 or an evaluation based thereon. That is, the evaluation of the perception unit 10, the determination unit 20, and the control unit 30 may be an evaluation of a closed loop.

### <Switching of Control Based on Allowable Time>

Hereinafter, switching of the control executed by the driving system 202, in particular, the determination unit 20 during traveling of the subject vehicle 1 will be described. The driving system 202 of the second embodiment switches the control action according to the acceptable time. That is, instead of the determination of the range for the state change in the first embodiment, or in combination with the determination of the range for the state change, the control action is derived using the acceptable time.

The use of the acceptable time increases the ease of follow-up verification of the driving system 202. When a determination result using the acceptable time and a time stamp are recorded in the recording device 55 as a set, the objective at the time of verification can be enhanced.

The driving system 202 continuously determines whether the parameter to be determined is within or outside the stable-control possible range R1. The driving system 202 continuously determines whether the parameter to be determined is within or outside the performance limit range R2. Here, the continuous determination means a determination in a mode in which it is possible to determine whether a state in which the parameter is within the performance limit range R2 and outside the stable-control possible range R1 continues for the acceptable time. The continuous determination may be, for example, a periodic determination at predetermined time intervals sufficiently shorter than the acceptable time.

Even when each parameter to be determined is within the performance limit range R2 and outside the stable-control possible range R1, the driving system 202 may derive a control action that is the same as or equivalent to that in the case where the parameter is within the stable-control possible range R1 as long as the state is not continued beyond the acceptable time.

The driving system 202 determines whether continuation of the state, in which a certain parameter is within the performance limit range R2 and outside the stable-control possible range R1, beyond the acceptable time has occurred. When the state of a certain parameter continues beyond the acceptable time, the recording device 55 records, as a set, a timing at which the state of the certain parameter being within the performance limit range R2 and outside the stable-control possible range R1 starts, a timing at which the acceptable time runs out, and a time stamp. Then, the driving system 202 performs a comprehensive determination including states of other parameters.

When the other parameters are within the stable-control possible range R1, the driving system 202 determines whether the overall control state is within or outside the performance limit range R2 based on whether the overall control state can be returned to the stable-control possible range R1. When the state of a certain parameter continues beyond the acceptable time, the other parameters are within the stable-control possible range R1, and the overall control state is within the performance limit range R2, the recording device 55 records, as a set, a fact of being in the state in which the control state can be returned to the stable-control possible range R1 and a time stamp.

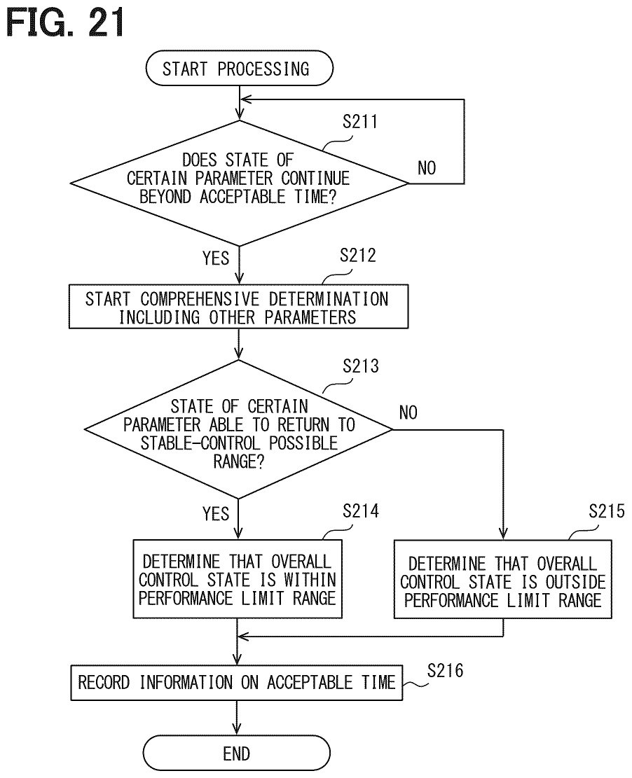

Hereinafter, an example of processing related to the determination of the control state in an operation flow of the driving system 202 will be described with reference to the flowchart in FIG. 21.

In S211, the determination unit 20 determines whether duration of a state in which a certain parameter is within the performance limit range R2 and outside the stable-control possible range R1 exceeds the acceptable time. If an affirmative determination is made in S211, the process proceeds to S212. If a negative determination is made in S211, the determination unit 20 performs the determination in S211 again after a predetermined time.

In S212, the determination unit 20 starts processing of determining whether the overall control state is within or outside the performance limit range R2 based on a comprehensive determination including other parameters. After the processing of S212, the process proceeds to S213.

In S213, the determination unit 20 determines, in consideration of interaction with other parameters, whether the state of the parameter determined in S211 can be returned to the stable-control possible range R1. If an affirmative determination is made in S213, the process proceeds to S214. If a negative determination is made in S213, the process proceeds to S215.

In S214, the determination unit 20 determines that the overall control state is within the performance limit range R2. After the processing of S214, the process proceeds to S216.

In S215, the determination unit 20 determines that the overall control state is outside the performance limit range R2. After the processing S215, the process proceeds to S216.

In S216, the recording device 55 records information on the acceptable time. The series of processing ends at S216.

According to the second embodiment described above, the MRM is executed when the condition indicating the continuation of the state in which the control state is within the performance limit range R2 and outside the stable-control possible range R1 is satisfied.

According to the second embodiment, in the execution of a best effort capable of guaranteeing a minimal risk, a continuation state of being within the performance limit range R2 and outside the stable-control possible range R1 is allowed for the set acceptable time. Since the control action of switching the control immediately after the control state becomes within the performance limit range R2 and outside the stable-control possible range R1 is restricted, the stability of the control can be improved.

According to the second embodiment, the acceptable time set for one parameter dynamically changes according to the determination of the range for the other parameters. Since the interaction between multiple parameters can be reflected in the acceptable time, the stability of the control can be further improved.

According to the second embodiment, when the state in which the control state is within the performance limit range R2 and outside the stable-control possible range R1 continues beyond the acceptable time, continuation beyond the acceptable time is recorded. Since a temporal condition among determination conditions for executing the MRM can be subjected to the follow-up verification, the reliability of the verification of the driving system 202 can be improved.

According to the second embodiment, a state in which a certain parameter among the multiple parameters is within the performance limit range R2 and outside the stable-control possible range R1 may be continued beyond the acceptable time, the other parameters may be within the stable-control possible range R1, and the overall control state may be within the performance limit range R2. In this case, a fact of being in the state in which the control state can be returned to the stable-control possible range R1 is recorded. Therefore, the determination result obtained by the driving system 202 when the MRM is executed can be easily subjected to follow-up verification.

According to the second embodiment, the stable-control possible range R1 is defined according to the nominal performance of the driving system 202 or the subsystem thereof, and the performance limit range R2 is defined according to the robust performance of the driving system 202 or the subsystem thereof. According to the configuration in which the control is switched by the control state determination based on the ranges R1 and R2, it is possible to match the performance of the driving system 202 or the subsystem with control suitable for the driving system 202 or the subsystem, and thus it is possible to improve the reliability of the control action.

### Third Embodiment

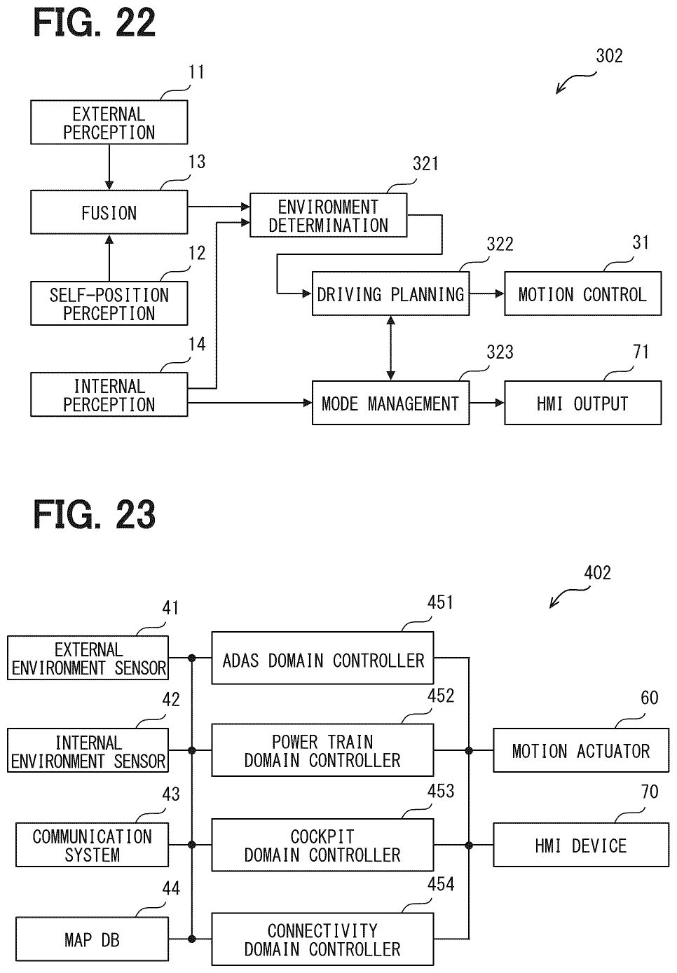

As illustrated in FIG. 22, a third embodiment is a modification of the first embodiment. The third embodiment will be described focusing on differences from the first embodiment.

In a driving system 302 of the third embodiment, direct input and output of information is not performed between the perception unit 10 and the control unit 30. That is, the information output by the perception unit 10 is input to the control unit 30 via the determination unit 20. For example, a vehicle state perceived by the internal perception unit 14, for example, at least one of the current speed, acceleration, and yaw rate of the subject vehicle 1 is transferred, without change, to the motion control unit 31 via an environment determination unit 321 and a driving planning unit 322, or via a mode management unit 323 and the driving planning unit 322.

That is, the environment determination unit 321 and the driving planning unit 322 or the mode management unit 323 and the driving planning unit 322 have a function of processing a part of information acquired from the internal perception unit 14 and outputting the processed information to the motion control unit 31 in the form of a trajectory plan or the like, and outputting another part of the information acquired from the internal perception unit 14 as unprocessed information to the motion control unit 31.

Accordingly, the interaction between the perception unit 10 and the control unit 30 in the physical IF layer of the causal loop illustrated in FIG. 5 is substantially implemented.

### Fourth Embodiment

As illustrated in FIG. 23, a fourth embodiment is a modification of the first embodiment. The fourth embodiment will be described focusing on differences from the first embodiment.

A driving system 402 of the fourth embodiment has a configuration in which a domain-type architecture that implements driving support up to Level 2 is adopted. An example of a detailed configuration of the driving system 402 at the technical level will be described with reference to FIG. 23.

Similarly to the first embodiment, the driving system 402 includes multiple sensors 41 and 42, multiple motion actuators 60, multiple HMI devices 70, multiple processing systems, and the like. Each processing system is a domain controller that aggregates processing functions for each functional domain. The domain controller may have the same configuration as the processing system or the ECU of the first embodiment. For example, the driving system includes, as processing systems, an ADAS domain controller 451, a power train domain controller 452, a cockpit domain controller 453, and a connectivity domain controller 454.

The ADAS domain controller 451 aggregates functions related to advanced driver-assistance systems (ADAS). The ADAS domain controller 451 may implement a part of the perception function, a part of the determination function, and a part of the control function in a combined manner. A part of the judgment function implemented by the ADAS domain controller 451 may be, for example, a function corresponding to the fusion unit 13 of the first embodiment or a simplified function thereof. A part of the determination function implemented by the ADAS domain controller 451 may be, for example, a function corresponding to the environment determination unit 21 and the driving planning unit 22 of the first embodiment or a simplified function thereof. A part of the control function implemented by the ADAS domain controller 451 may be, for example, a function of generating request information to the motion actuator 60 among functions corresponding to the motion control unit 31 of the first embodiment.

Specifically, the function implemented by the ADAS domain controller 451 is a function of performing travel support in a non-hazardous scenario, such as a lane keeping support function of causing the subject vehicle 1 to travel along a lane line and a vehicle-to-vehicle distance keeping function of following a preceding vehicle located in front of the subject vehicle 1 with a predetermined vehicle-to-vehicle distance therebetween. In addition, the function implemented by the ADAS domain controller 451 is a function of implementing a proper response in a hazardous scenario, such as a collision damage mitigation brake function of applying a brake when the vehicle is likely to collide with another road user or an obstacle, and an automatic steering avoidance function of avoiding a collision by steering when the vehicle is likely to collide with another road user or an obstacle.

The power train domain controller 452 aggregates functions related to control of a power train. The power train domain controller 452 may implement at least a part of the perception function and at least a part of the control function in a combined manner. A part of the perception function implemented by the power train domain controller 452 may be, for example, a function of perceiving an operating state of the driver for the motion actuator 60 among functions corresponding to the internal perception unit 14 of the first embodiment. A part of the control function implemented by the power train domain controller 452 may be, for example, a function of controlling the motion actuator 60 among functions corresponding to the motion control unit 31 of the first embodiment.

The cockpit domain controller 453 aggregates functions related to the cockpit. The cockpit domain controller 453 may implement at least a part of the perception function and at least a part of the control function in a combined manner. A part of the perception function implemented by the cockpit domain controller 453 may be, for example, a function of perceiving a switch state of the HMI device 70 in the internal perception unit 14 of the first embodiment. A part of the control function implemented by the cockpit domain controller 453 may be, for example, a function corresponding to the HMI output unit 71 of the first embodiment.

The connectivity domain controller 454 aggregates functions related to connectivity. The connectivity domain controller 454 may implement at least part of the perception function in a combined manner. A part of the perception function implemented by the connectivity domain controller 454 may be a function of organizing and converting global position data, V2X information, and the like of the subject vehicle 1 acquired from the communication system 43 into, for example, a format usable by the ADAS domain controller 451.

Also in the fourth embodiment, for example, at least one of the performance limit range R2 and the stable-control possible range R1 can be used in an operating condition for causing the ADAS domain controller 451 to operate an application such as a collision damage mitigation brake or automatic steering avoidance.

### Other Embodiments

Although multiple embodiments have been described above, the present disclosure is not limited to the embodiments, and can be applied to various embodiments and combinations without departing from the gist of the present disclosure.

For example, in the first embodiment, the stable-control possible range R1 may be defined according to the nominal performance of the entire driving system 2, and the performance limit range R2 may be defined according to the robust performance of the entire driving system 2. In the first embodiment, the stable-control possible range R1 may be defined according to the nominal performance of the determination unit 20, and the performance limit range R2 may be defined according to the robust performance of the determination unit 20.

The control unit and the method thereof described in the present disclosure may be implemented by a dedicated computer constituting a processor programmed to execute one or more functions embodied by a computer program. Alternatively, the device and the method thereof according to the present disclosure may be implemented by a dedicated hardware logic circuit. Alternatively, the device and the method thereof according to the present disclosure may be implemented by one or more dedicated computers implemented by a combination of a processor that executes a computer program and one or more hardware logic circuits. The computer program may be stored in a computer-readable non-transitory tangible recording medium as an instruction to be executed by a computer.

### DESCRIPTION OF TERMS

The terms related to the present disclosure will be described below. This description is included in embodiments of the present disclosure.

The road user may be “anyone who uses a road including a sidewalk and other adjacent space”. The road user may be “a road user on or adjacent to an active road for the purpose of moving from a certain location to another location”.

The dynamic driving task (DDT) may be “real-time operational and tactical functions required to operate a vehicle in traffic”.

The autonomous driving system may be “hardware and software that are collectively capable of performing the entire DDT on a sustained basis, regardless of whether or not the autonomous driving system is limited to a specific operational design domain”.

The safety of the intended functionality (SOTIF) may be “absence of unreasonable risks due to inadequacy of the intended functionality or its implementation”.

The driving policy may be “strategy and rules defining acceptable actions at the vehicle level.

The vehicle motion may be “vehicle state and dynamics thereof in terms of physical quantities (for example, a speed and an acceleration)”.

The situation may be “factor that may affect the behavior of the system. The situation, the traffic condition, the weather, and the behavior of the subject vehicle may be included.

The estimation of the situation may be “reconstruction of a parameter group representing the situation by an electronic system from the situation obtained from the sensor”.

The scenario may be “description of a temporal relationship between several scenes, with goals and values within a specified situation in a sequence of scenes influenced by actions and events. The scenario may be “description of consecutive time series of activities integrates the subject vehicle, all its external environment, and their interaction in the process of performing a certain driving task.

The behavior of the subject vehicle may be “interpretation of the vehicle motion based on traffic conditions”.

The triggering condition may be “specific condition of a scenario that serves as an initiator for a subsequent system reaction contributing to either a hazardous behavior and reasonably foreseeable indirect misuse, which is a subsequent reaction of the system.

The proper response may be “action for remediation of hazardous situation when other road users act in accordance with an assumption about reasonably foreseeable behaviors”.

The hazardous situation may be “a scenario that represents a level of increased risk present in the DDT unless preventative action is taken”.

The safe situation may be “situation in which the system is within the performance limit that ensures safety. It should be noted that the safe situation is a design concept based on the definition of the performance limit.

The minimal risk maneuver (MRM) may be “(automated) driving system's capability of transitioning the vehicle between nominal and minimal risk conditions.

The DDT fallback may be “response by the driver or automation system to either perform the DDT or transition to a minimal risk condition after the occurrence of a failure(s) or detection of a functional insufficiency or upon detection of a potentially hazardous behavior.

The performance limit may be “design limit value at which the system can achieve its objectives”. The performance limit can be set for multiple parameters.

The operational design domain (ODD) may be “specific conditions under which a given (automated) driving system is designed to function. The operational design domain is “operating conditions under which a given (automated) driving system or feature thereof is specifically designed to function, including, but not limited to, environmental, geographical, and time-of-day restrictions, and/or the requisite presence of certain traffic or roadway characteristics”.

The (stable) control possible range may be “range of design values in which the system can continue its objectives”. The (stable) control possible range can be set for multiple parameters.

The minimal risk condition (MRC) may be “vehicle state in order to reduce the risk, when a given trip cannot be completed”. The minimal risk condition may be “condition to which a user or an automated driving system may bring a vehicle after performing the MRM in order to reduce the risk of a crash when a given trip cannot be completed”.

The takeover may be “transfer of the driving task between the automated driving system and the driver”.

The unreasonable risk may be “risk judged to be unacceptable in a certain context according to valid social moral concepts”.

The acceptable time may be “a period in which a state within the performance limit range and outside the stable-control possible range may be continued”. The acceptable time may be set in design by considering (and evaluating) the robust performance.

The reacting vehicle behavior means that the behavior of the vehicle changes in response to a situation change, and may be control based on a control action determined by an external factor such as other road users.

### APPENDIX

The present disclosure also includes the following technical ideas based on the above embodiments.

### <Technical Feature 1>

An evaluation method of a driving system of a moving object, which includes a perception system, a determination system, and a control system as subsystems, the method including:
evaluating nominal performance of the perception system;
evaluating nominal performance of the determination system; and
evaluating nominal performance of the control system.

### <Technical Feature 2>

An evaluation method of a driving system of a moving object, which includes a perception system, a determination system, and a control system as subsystems, the method including:
evaluating nominal performance of the determination system; and
evaluating robustness of the determination system in consideration of at least one of an error of the perception system and an error of the control system.

### <Technical Feature 3>

An evaluation method of a driving system of a moving object, which includes a perception system, a determination system, and a control system as subsystems, the method including:
independently evaluating each of nominal performance of the perception system, nominal performance of the determination system, and nominal performance of the control system; and
evaluating robustness of an entire driving system such that a composite factor of the perception system and the determination system, a composite factor of the determination system and the control system, and a composite factor of the perception system and the control system are included in an object to be evaluated.

### <Technical Feature 4>

A design method of a driving system of a moving object, which includes a perception system, a determination system, and a control system as subsystems, the method including:
setting a stable-control possible range of a control state of the moving object based on nominal performance of the perception system and nominal performance of the control system; and
setting an acceptable time for allowing a state in which the control state is within a performance limit range and outside the stable-control possible range, based on evaluation of robust performance of the determination system in consideration of at least one of an error of the perception system and an error of the control system.

### <Technical Feature 5>

A processing system for implementing a dynamic driving task of a moving object, including:
at least one processor, in which
the processor is configured to
define, as ranges indicating a control state of the moving object, a performance limit range that is a range having a performance limit of a driving system as a boundary and a stable-control possible range in which stable control is maintainable within the performance limit range, and
determine whether or not a minimal risk is possible to be guaranteed according to the range of the control state in execution of a best effort as a control action.

### <Technical Feature 6>

A processing system for implementing a dynamic driving task of a moving object, including:
at least one processor, in which
the processor is configured to
acquire a situation perceived in relation to an external factor,
determine whether a behavior of the moving object is possible to return to a stable state when the behavior of the moving object is in an unstable state due to an event caused by the external factor, and
derive a control action of the moving object as a reaction to the perceived situation so as to switch control according to the determination.

### <Technical Feature 7>

A processing system for implementing a dynamic driving task of a moving object, including:
a processor, in which
the processor is configured to
determine whether a behavior of the moving object is possible to return to a stable state when the behavior of the moving object is in an unstable state, and
execute a transient response when it is determined that the behavior is possible to return to the stable state.

### <Technical Feature 8>

A processing device for executing processing related to a dynamic driving task of a moving object, including:
at least one processor; and
an interface, in which
the processor is configured to
acquire information on stability of a behavior of the moving object through the interface,
set a restriction for switching control related to a dynamic driving task according to the information on stability of the behavior of the moving object, and
output the restriction through the interface.

### <Technical Feature 9>

An SoC implemented by integrating a memory, a processor, and an interface into one chip, in which
the SoC
acquires information on stability of a behavior of a moving object through the interface,
sets a restriction for switching control by a driving system according to the information on stability of the behavior of the moving object, and
outputs the restriction through the interface.

### <Technical Feature 10>

A recording device for recording a state of a driving system of a moving object, in which
the recording device records
a fact that the driving system has executed a best effort as a control action, and
information indicating whether a behavior of the moving object is in a stable state or an unstable state, which is used for determination to execute the best effort.

### <Technical Feature 11>

A method of generating data for recording a state of a driving system of a moving object, the method including:
generating data indicating that the driving system has executed a best effort as a control action; and
generating data indicating a control state of the moving object used for determination to execute the best effort, the data being a set with the data indicating that the driving system has executed the best effort.

### <Technical Feature 12>

A recording device for recording a state of a driving system of a moving object, in which
the recording device records
a fact that the driving system has executed a transient response as a control action, and
information indicating whether a behavior of the moving object is in a stable state or an unstable state, which is used for determination to execute a transient response.

### <Technical Feature 13>

A method of generating data for recording a state of a driving system of a moving object, the method including:
generating data indicating that the driving system has executed a transient response as a control action; and
generating data indicating a control state of the moving object used for determination to execute a best effort, the data being a set with the data indicating that the driving system has executed the transient response.

### <Technical Feature 14>

A processing device to be used in a driving system, the driving system including a perception system, a determination system, and a control system as subsystems, the processing device including:
at least one processor, in which
the processor is configured to
determine whether a control state of a moving object is within a first range set based on nominal performance of the driving system or the subsystem,
determine whether the control state of the moving object is within a second range set based on robustness of the driving system or the subsystem, and
derive a control action of the moving object so as to switch control according to the first range and the second range.

According to this configuration, since the control is switched by the control state determination based on the ranges R1 and R2, it is possible to match the performance of the driving system 2 or the subsystem with the control suitable for the driving system 2 or the subsystem. Therefore, the reliability of the control action can be enhanced.

### <Technical Feature 15>

The processing device according to technical feature 14, in which
the processor is configured to
further determine whether the driving system is within an operational design domain set outside the first range and within the second range, and
derive the control action of the moving object so as to switch the control according to the first range, the second range, and the operational design domain.

### <Technical Feature 16>

The processing device according to technical feature 15, in which
the processor is configured to derive, as the control action, a best effort capable of guaranteeing a minimal risk when the driving system deviates from the operational design domain.

What is claimed is:

1. A method to be executed by at least one processor to implement a dynamic driving task in a driving system of a moving object, the method comprising:
defining, as ranges indicating a control state of the moving object, a performance limit range that is a range having a performance limit of the driving system as a boundary and a stable-control possible range in which stable control is maintainable within the performance limit range;
determining the range such that a determination as to whether the control state is within or outside the stable-control possible range is included; and
deriving a control action of the moving object so as to switch control according to the determination.

2. The method according to claim 1, wherein
the determining the range includes determining whether the control state is within or outside the performance limit range, and
in the deriving the control action, the control action is switched based on a switching condition set according to a determination result of whether the control state is within the stable-control possible range, is within the performance limit range and outside the stable-control possible range, or is outside the performance limit range.

3. The method according to claim 2, wherein
when a condition indicating continuation of the control state being within the performance limit range and outside the stable-control possible range is satisfied, minimal risk maneuver (MRM) is executed in the deriving the control action.

4. The method according to claim 2, wherein
when the control state is outside the performance limit range, a best effort with which the driving system attempts to minimize a risk within control capacity is executed in the deriving the control action.

5. The method according to claim 1, wherein
the determining the range includes determining the range for a plurality of parameters, and
the plurality of parameters include a state parameter indicating a current state of the control state and a state change parameter indicating a state change of the control state.

6. The method according to claim 1, further comprising:
estimating a situation in which the moving object is placed,
wherein
the determining the range is performed based on the situation, and
in the defining, the performance limit range and the stable-control possible range are set based on a difference between the situation estimated by the processor and a real world.

7. The method according to claim 1, further comprising:
setting an acceptable time for allowing a continuation state of being within the performance limit range and outside the stable-control possible range, which is used as a condition for switching the control action.

8. The method according to claim 1, wherein
the determining the range includes determining the range for a plurality of parameters,
the method further comprising:
setting, for each of the plurality of parameters, an acceptable time for allowing a continuation state of being within the performance limit range and outside the stable-control possible range, which is used as a condition for switching the control action,
wherein
in the setting, the acceptable time set for one of the plurality of parameters is dynamically changed according to determination of the range for another parameter.

9. The method according to claim 1, wherein
the stable-control possible range is defined according to nominal performance of the driving system or a subsystem of the driving system, and
the performance limit range is defined according to robustness of the driving system or the subsystem.

10. The method according to claim 1, wherein
in the defining, the performance limit range and the stable-control possible range are defined such that an operational design domain of the driving system is within the performance limit range and the stable-control possible range.

11. A processing system for implementing a dynamic driving task of a moving object comprising:
at least one processor,
wherein
the processor is configured to:
define, as ranges indicating a control state of the moving object, a performance limit range that is a range having a performance limit of a driving system of the moving object as a boundary and a stable-control possible range in which stable control is maintainable within the performance limit range;
determine the range such that a determination as to whether the control state is within or outside the stable-control possible range is included; and
derive a control action of the moving object so as to switch control according to the determination.

12. A recording device for recording a state of a driving system of a moving object,
wherein
the recording device records:
defining, as ranges indicating a control state of the moving object, a performance limit range that is a range having a performance limit of the driving system as a boundary and a stable-control possible range in which stable control is maintainable within the performance limit range;
a fact that the driving system has executed minimal risk maneuver (MRM); and
information indicating which range of the ranges the control state is in, the information being used for determination to execute the MRM and the information being determined based on a situation estimated by the driving system.

13. The recording device according to claim 12, wherein
an acceptable time for allowing continuation of a state in which the control state is within the performance limit range and outside the stable-control possible range is included in a determination condition for executing the MRM, and
when the state in which the control state is within the performance limit range and outside the stable-control possible range is continued beyond the acceptable time, a fact that the acceptable time is exceeded is further recorded.

14. The recording device according to claim 13, wherein
for a plurality of parameters indicating the control state, the driving system determines which range of the ranges each parameter is in,
when a state in which a certain parameter among the plurality of parameters is within the performance limit range and outside the stable-control possible range is continued beyond the acceptable time, another parameter is within the stable-control possible range, and further an overall control state is within the performance limit range, a fact that the control state is in a state of being able to return to the stable-control possible range is further recorded.
